(19) United States
(12) Patent Application Publication
(10) Pub. No.: US 2026/0149965 A1
(43) Pub. Date: May 28, 2026

(54) AUTHENTICATION AND SECURITY FOR ULTRA-HIGH RELIABILITY (UHR) ROAMING

(71) Applicant: QUALCOMM Incorporated, San Diego, CA (US)

(72) Inventors: Sai Yiu Duncan HO, San Diego, CA (US); George CHERIAN, San Diego, CA (US); Jouni Kalevi MALINEN, Tuusula (FI); Giovanni CHISCI, San Diego, CA (US); Abhishek Pramod PATIL, San Diego, CA (US); Alfred ASTERJADHI, San Diego, CA (US); Gaurang NAIK, San Diego, CA (US); Sanket Sanjay KALAMKAR, San Diego, CA (US); Sherief HELWA, San Diego, CA (US)

(21) Appl. No.: 19/398,652

(22) Filed: Nov. 24, 2025

Related U.S. Application Data
(60) Provisional application No. 63/724,876, filed on Nov. 25, 2024.

(51) Int. Cl. H04W 12/041; H04W 8/08; H04W 12/069

(52) U.S. Cl. CPC H04W 12/041; H04W 8/08; H04W 12/069

(57) ABSTRACT

This disclosure provides methods, components, devices and systems for authentication and security for ultra-high reliability (UHR) roaming. Some aspects more specifically relate to devices in a seamless mobility domain (SMD), such as access point (AP) multi-link devices (MLDs) and non-AP MLDs, supporting the generation of different temporal keys (TKs) for each AP MLD. For example, the non-AP MLD may establish, via authenticator associated with the SMD, a pairwise master key security association (PMKSA) and a single pairwise transient key security association (PTKSA). Thus, the non-AP MLD may communicate with a first AP MLD (such as of multiple AP MLDs associated with the SMD) in accordance with a first pairwise transient key (PTK) and, after roaming to a second AP MLD (such as of the multiple AP MLDs), may communicate with the second AP MLD in accordance with a second PTK, where the second TK is different than the first PTK.

### CROSS REFERENCES

The present Application for Patent claims benefit of U.S. Provisional Ser. No. 63/724,876 by HO et al., entitled “AUTHENTICATION AND SECURITY FOR ULTRA-HIGH RELIABILITY (UHR) ROAMING,” filed Nov. 25, 2024, assigned to the assignee hereof, and expressly incorporated herein.

### TECHNICAL FIELD

This disclosure relates generally to wireless communication and, more specifically, to authentication and security for ultra-high reliability (UHR) roaming.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One aspect of the subject matter described in the disclosure can be implemented in a method for wireless communications by a wireless station (STA) device is described. The method may include establishing, via an authenticator associated with a seamless mobility domain (SMD), a pairwise master key security association (PMKSA) and a single pairwise transient key security association (PTKSA) associated with a first access point (AP) device and a second AP device, the single PTKSA associated with a key derivation key (KDK), communicating with the first AP device associated with the SMD in accordance with a first pairwise temporal key (PTK), where the first PTK is generated in accordance with the KDK and a first identifier of the first AP device, roaming from the first AP device to a second AP device associated with the SMD, and communicating with the second AP device in accordance with a second PTK, different from the first PTK, where the second PTK is generated in accordance with the KDK and a second identifier of the second AP device.

Another aspect of the subject matter described in the disclosure can be implemented in an STA device for wireless communications is described. The STA device may include a processing system that includes processor circuitry and memory circuitry that stores code. The processing system may be configured to cause the STA device to establish, via an authenticator associated with an SMD, a PMKSA and a single PTKSA associated with a first AP device and a second AP device, the single PTKSA associated with a KDK, communicate with the first AP device associated with the SMD in accordance with a first PTK, where the first PTK is generated in accordance with the KDK and a first identifier of the first AP device, roam from the first AP device to a second AP device associated with the SMD, and communicate with the second AP device in accordance with a second PTK, different from the first PTK, where the second PTK is generated in accordance with the KDK and a second identifier of the second AP device.

Another aspect of the subject matter described in the disclosure can be implemented in another STA device for wireless communications is described. The STA device may include means for establishing, via an authenticator associated with an SMD, a PMKSA and a single PTKSA associated with a first AP device and a second AP device, the single PTKSA associated with a KDK, means for communicating with the first AP device associated with the SMD in accordance with a first PTK, where the first PTK is generated in accordance with the KDK and a first identifier of the first AP device, means for roaming from the first AP device to a second AP device associated with the SMD, and means for communicating with the second AP device in accordance with a second PTK, different from the first PTK, where the second PTK is generated in accordance with the KDK and a second identifier of the second AP device.

Another aspect of the subject matter described in the disclosure can be implemented in a non-transitory computer-readable medium storing code for wireless communications is described. The code may include instructions executable by one or more processors to establish, via an authenticator associated with an SMD, a PMKSA and a single PTKSA associated with a first AP device and a second AP device, the single PTKSA associated with a KDK, communicate with the first AP device associated with the SMD in accordance with a first PTK, where the first PTK is generated in accordance with the KDK and a first identifier of the first AP device, roam from the first AP device to a second AP device associated with the SMD, and communicate with the second AP device in accordance with a second PTK, different from the first PTK, where the second PTK is generated in accordance with the KDK and a second identifier of the second AP device.

In some examples of the method, STA devices, and non-transitory computer-readable medium described herein, the first PTK and the second PTK may be different PTKs in accordance with the first PTK and the second PTK being per-AP MLD PTKs.

In some examples of the method, STA devices, and non-transitory computer-readable medium described herein, the first PTK and the second PTK are generated in accordance with an identifier of the SMD.

In some examples of the method, STA devices, and non-transitory computer-readable medium described herein, communicating with the first AP device may include operations, features, means, or instructions for receiving, from the first AP device, a first set of packets, where a last received packet of the first set of packets may be associated with a first packet number (PN), and where communicating with the second AP device may include operations, features, means, or instructions for receiving, from the second AP device, a second set of packets, where a first received packet of the second set of packets may be associated with a second PN that may be subsequent to the first PN.

In some examples of the method, STA devices, and non-transitory computer-readable medium described herein, the first identifier of the first AP device comprises a first medium access control (MAC) address of the first AP device, and where the second identifier of the second AP device includes a second MAC address of the second AP device.

Some examples of the method, STA devices, and non-transitory computer-readable medium described herein may further include operations, features, means, or instructions for receiving, from the authenticator, an indication of a first pseudo-random number, where each of the first PTK and the second PTK may be further generated in accordance with the first pseudo-random number, a second pseudo-random number generated by the STA device, or both.

Some examples of the method, STA devices, and non-transitory computer-readable medium described herein may further include operations, features, means, or instructions for transmitting, to the authenticator, an indication of the second pseudo-random number.

In some examples of the method, STA devices, and non-transitory computer-readable medium described herein, a pairwise master key (PMK) associated with the PMKSA may be generated in accordance with an identifier of the SMD.

Some examples of the method, STA devices, and non-transitory computer-readable medium described herein may further include operations, features, means, or instructions for receiving an indication that the single PTKSA is to be used, where the one or more PTKSAs may include the single PTKSA in accordance with one or more parameters of the SMD, and where the one or more parameters may be based on a network capability, a network configuration, or both.

Some examples of the method, STA devices, and non-transitory computer-readable medium described herein may further include operations, features, means, or instructions for receiving an indication to use per-AP multi-link device (MLD) PTKs, where use of per-AP MLD PTKs may be in accordance with one or more parameters of the SMD, where the one or more parameters may be based on a network capability, a network configuration, or both, and where the first PTK being different than the second PTK may be in accordance with the indication.

In some examples of the method, STA devices, and non-transitory computer-readable medium described herein, the STA device may support fast basic service set (BSS) transition (FT) roaming within an FT domain, including at least the SMD, and supports seamless roaming within the SMD, where the PMKSA may be associated with both a pairwise master key-R0 (PMK-R0) and a PMK-R1, and where the PMK-R1 may be generated in accordance with an identifier of the SMD.

In some examples of the method, STA devices, and non-transitory computer-readable medium described herein, the first PTK and the second PTK may be generated in accordance with the PMK-R1.

In some examples of the method, STA devices, and non-transitory computer-readable medium described herein, a mobility domain identifier associated with the PMK-R0 for seamless roaming may be an identifier of the SMD.

Some examples of the method, STA devices, and non-transitory computer-readable medium described herein may further include operations, features, means, or instructions for transmitting an indication of preference that the PMK-R0 and the PMK-R1 support seamless roaming, where the PMK-R1 may be generated in accordance with the identifier of the SMD based on the preference.

Some examples of the method, STA devices, and non-transitory computer-readable medium described herein may further include operations, features, means, or instructions for transmitting, to the first AP device, a request to roam to the second AP device, where the request may be encrypted in accordance with the first PTK, and receiving, from the first AP device, a response acknowledging the request to roam, where the response may be encrypted in accordance with the first PTK.

Another aspect of the subject matter described in the disclosure can be implemented in a method for wireless communications by a first AP device associated with an SMD is described. The method may include establishing a PMKSA and a PTKSA, the PTKSA associated with the first AP and a second AP in the SMD, the PTKSA associated with a key derivation key (KDK), and communicating with an STA device in accordance with a first PTK, where the first PTK is generated in accordance with the KDK and a first identifier of the first AP device, and where the first PTK is different from a second PTK associated with a second AP device in the SMD.

Another aspect of the subject matter described in the disclosure can be implemented in a first AP device associated with an SMD for wireless communications is described. The first AP device associated with an SMD may include a processing system that includes processor circuitry and memory circuitry that stores code. The processing system may be configured to cause the first AP device associated with an SMD to establish a PMKSA and a PTKSA, the PTKSA associated with the first AP and a second AP in the SMD, the PTKSA associated with a key derivation key (KDK), and communicate with an STA device in accordance with a first PTK, where the first PTK is generated in accordance with the KDK and a first identifier of the first AP device, and where the first PTK is different from a second PTK associated with a second AP device in the SMD.

Another aspect of the subject matter described in the disclosure can be implemented in another first AP device associated with an SMD for wireless communications is described. The first AP device associated with an SMD may include means for establishing a PMKSA and a PTKSA, the PTKSA associated with the first AP and a second AP in the SMD, the PTKSA associated with a key derivation key (KDK), and means for communicating with an STA device in accordance with a first PTK, where the first PTK is generated in accordance with the KDK and a first identifier of the first AP device, and where the first PTK is different from a second PTK associated with a second AP device in the SMD.

Another aspect of the subject matter described in the disclosure can be implemented in a non-transitory computer-readable medium storing code for wireless communications is described. The code may include instructions executable by one or more processors to establish a PMKSA and a PTKSA, the PTKSA associated with the first AP and a second AP in the SMD, the PTKSA associated with a key derivation key (KDK), and communicate with an STA device in accordance with a first PTK, where the first PTK is generated in accordance with the KDK and a first identifier of the first AP device, and where the first PTK is different from a second PTK associated with a second AP device in the SMD.

### BRIEF DESCRIPTION OF THE DRAWINGS

FIG. 1 shows a pictorial diagram of an example wireless communication network.

FIG. 2 shows example key architectures that supports authentication and security for ultra-high reliability (UHR) roaming.

FIG. 3 shows an example of a process flow that supports authentication and security for UHR roaming.

FIG. 4 shows an example of a process flow that supports authentication and security for UHR roaming.

FIG. 5 shows an example of a timing diagram that supports authentication and security for UHR roaming.

FIG. 6 shows example domain architectures that supports authentication and security for UHR roaming.

FIG. 7 shows an example of a process flow that supports authentication and security for UHR roaming.

FIG. 8 shows a block diagram of an example wireless communication device that supports authentication and security for UHR roaming.

FIG. 9 shows a block diagram of an example wireless communication device that supports authentication and security for UHR roaming.

FIG. 10 shows a flowchart illustrating an example process performable by or at a wireless station (STA) device that supports authentication and security for UHR roaming.

FIG. 11 shows a flowchart illustrating an example process performable by or at a first access point (AP) device associated with a seamless mobility domain (SMD) that supports authentication and security for UHR roaming.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. Some or all of the described implementations may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described implementations can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described implementations also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a non-access point (non-AP) device may support seamless roaming between AP multi-link device (MLDs) in a seamless mobility domain (SMD). For example, multiple non-co-located AP MLDs may be associated with an SMD, such that a non-AP MLD (such as a wireless station (STA) MLD) may be capable of roaming seamlessly between AP MLDs in the SMD by staying in a connect state (such as a State 4) with both a serving AP MLD and a target AP MLD when roaming from the serving AP MLD to the target AP MLD (such as for a threshold, or brief duration when roaming from the serving AP MLD to the target AP MLD). In such implementations, to enable the seamless roaming within the SMD, the non-AP MLD may perform an authentication procedure with an authenticator associated with the SMD to establish a pairwise master key security association (PMKSA) and a pairwise transient key security association (PTKSA). Additionally, each AP MLD in the SMD may support a same PMKSA and PTKSA, such that each AP MLD in the SMD, as well as the non-AP MLD, may generate a same pairwise transient key (PTK) and thus a same temporal key (TK) (in accordance with the PTK). However, using a same TK may result in security vulnerabilities (such as in some deployments where security is not strong enough, or is below a threshold, in a backhaul). For example, the non-AP MLD and the multiple AP MLDs may encrypt communications between the non-AP MLD and each AP MLD using the TK and, in some implementations, the TK may be shared between AP MLDs (of the multiple AP MLDs). However, sharing of the TK may enable another device (such as an attacker) to intercept the TK and, if intercepted, the other device may be capable of decrypting communications between the non-AP MLD and any of the AP MLDs due to the multiple AP MLDs (and the non-AP MLD) using the same TK.

Various aspects relate generally to security enhancements for seamless roaming in an SMD. Some aspects more specifically relate to devices associated with the SMD, such as AP MLDs and non-AP MLDs devices, supporting the generation of different TKs for each AP MLD, which may be referred to as per-AP MLD TKs. For example, the non-AP MLD may establish, via an authenticator associated with the SMD, a PMKSA and one or more PTKSAs. Thus, the non-AP MLD may communicate with a first AP MLD (of multiple AP MLDs associated with the SMD) in accordance with a first TK and, after roaming to a second AP MLD (of the multiple AP MLDs), may communicate with the second AP MLD in accordance with a second TK, where the second TK is different than the first TK.

In some implementations, the one or more PTKSAs may include a single PTKSA. In such implementations, the non-AP MLD may generate a key derivation key (KDK) associated with the single PTKSA, where a first pairwise transient key (PTK), and thus the first TK, is generated in accordance with the KDK and a first medium access control (MAC) address of the first AP MLD, and a second PTK, and thus the second TK, is generated in accordance with the KDK and a second MAC address of the second AP MLD. In some other implementations, the TK generated for an AP MLD may use some random values exchanged between the non-AP MLD and the authenticator (such as an ANonce and an SNonce) as part of inputs to generate the TK (such as in combination with the KDK and a respective MAC address). In some other implementations, the one or more PTKSAs may include a first PTKSA associated with the first AP MLD (and established in accordance with the first MAC address) and a second PTKSA associated with the second AP MLD (and established in accordance with the second MAC address). In such implementations, the first PTKSA may be associated with a first PTK used to generate the first TK and the second PTKSA may be associated with a second PTK, different than the first PTK, used to generate the second TK, where the first TK and the second TK are different in accordance with the first PTK and the second PTK being different.

In some implementations, the non-AP MLD may additionally support a common TK associated with both the first AP MLD and the second AP MLD. For example, rather than the first TK and the second TK being different, the first TK and the second TK may be the common TK. In such implementations, the non-AP MLD may communicate (such as transmit or receive) an indication to use either the per-AP MLD TKs or the common TK.

Particular aspects of the subject matter described in this disclosure can be implemented to realize one or more of the following potential advantages. In some implementations, by supporting the per-AP MLD TKs, the described techniques can be used to improve security in the SMD. For example, using per-AP MLD TKs may prevent a malicious device from being able to decrypt communications between the non-AP MLD and all AP MLD devices in the SMD in the case that the malicious device intercepts, or determines, a single TK (such as due to the single TK only being used for a respective AP MLD). Additionally, by enabling the non-AP MLD to communicate the indication to use either the per-AP MLD TKs or the common TK, the described techniques can be used to enable some deployments to support a higher level of security and some other deployments to support a lower level of security (such as in accordance with system requirements).

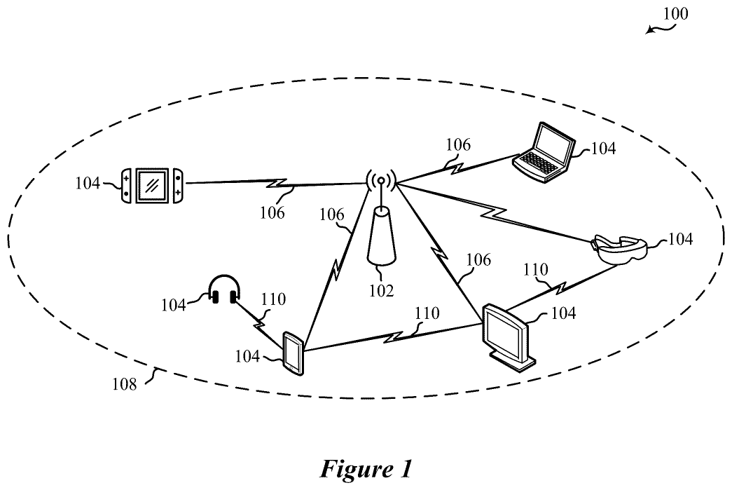

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other implementations, the wireless communication network 100 can be an example of a cellular radio access network (RAN), such as a 5G or 6G RAN that implements one or more cellular protocols such as those specified in one or more 3GPP standards. In some other implementations, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other implementations, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other implementations. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other implementations.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some implementations, ad hoc networks may be implemented within a larger network such as the wireless communication network 100. In such implementations, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Implementations of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some implementations of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-(52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some implementations, the control frame and fields within the MAC header of the data or management frames, or both, also may be secured either via encryption or via an integrity check (such as by generating a message integrity check (MIC) for one or more relevant fields.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some implementations, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some implementations, the exchange of information may occur via a beacon frame, a probe request frame, a probe response frame, an association request frame, an association response frame, another management frame, a dedicated action frame, or an operating mode indicator (OMI), among other implementations. In some implementations, an AP MLD may designate a specific channel of one link in one of the bands as an anchor channel on which it transmits beacons and other control or management frames periodically. In such implementations, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some implementations be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some implementations, the parallel communication links may support synchronized transmissions. In some other implementations, or during some other durations of time, transmissions over the communication links may be parallel, but not be synchronized or concurrent. Additionally, in some implementations or durations of time, two or more of the communication links may be used for communications between MLDs in the same direction (such as all uplink or all downlink), while in some other implementations or durations of time, two or more of the communication links may be used for communications in different directions (such as one or more communication links may support uplink communications and one or more communication links may support downlink communications). In such implementations, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other implementations, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some implementations, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some implementations, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In implementations in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

In some implementations, the wireless communication network 100 may support generation of per-AP MLD TKs. For example, an STA MLD (such as including one or more STAs 104) may establish, via an authenticator associated with an SMD, a PMKSA and one or more PTKSAs. Thus, the STA MLD may communicate with a first AP MLD (such as including one or more first APs 102) associated with the SMD in accordance with a first TK and, after roaming to a second AP MLD (such as including one or more second APs 102) associated with the SMD, may communicate with the second AP MLD in accordance with a second TK, where the second TK is different than the first TK.

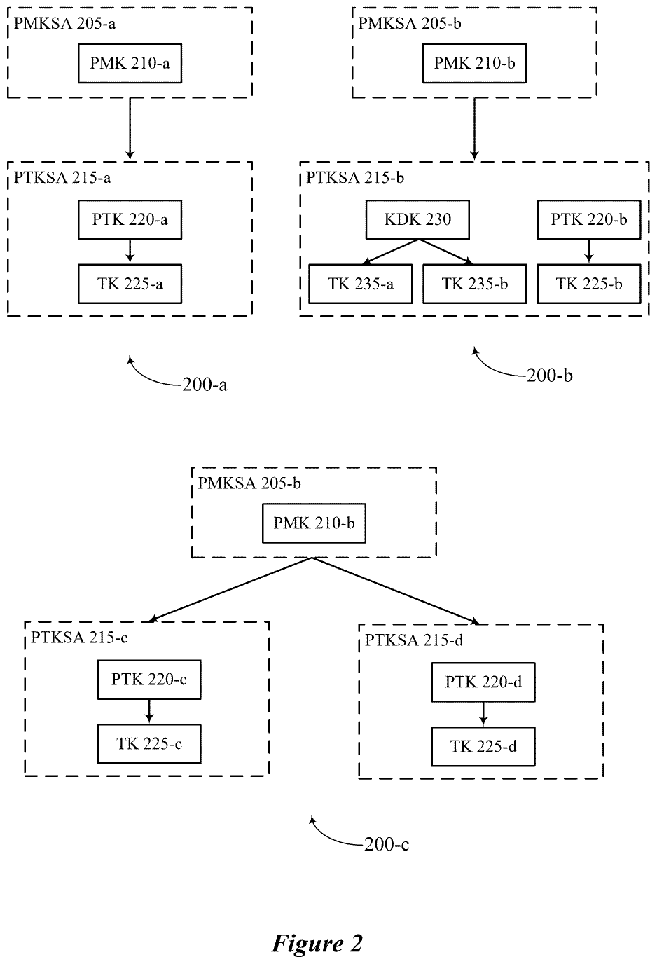

FIG. 2 shows example key architectures 200 that supports authentication and security for UHR roaming. In some implementations, the key architectures 200 may implement or be implemented by aspects of the example wireless communication network 100. For example, the key architectures 200 may be implemented by one or more STAs 104 (of an STA MLD), one or more APs 102 (of one or more AP MLDs), or both, as described with reference to FIG. 1.

Some wireless communications systems may support a UHR SMD, which may simply be referred to as an SMD, where the SMD includes multiple non-co-located AP MLDs (each including one or more APs 102). In such implementations, a non-AP MLD, which also may be referred to as an STA MLD (including one or more STAs 104), may seamlessly roam between the non-co-located AP MLDs. For example, the non-AP MLD may roam (seamlessly) from a serving AP MLD to a target AP MLD and, in such implementations, may remain in a connected state (such as a State 4) with both the serving AP MLD and the target AP MLD for a duration (such as a brief duration, a duration less than a threshold duration) during the roaming. In some examples, the connected state may be a State 4, where the State 4 may refer to the connection state machine in the non-AP MLD being in a fully authenticated and associated connection state with the serving AP MLD and target AP MLD (such as where State 0 may refer to not authenticated or associated, State 1 may refer to authenticated but not associated, State 3 may refer to authenticated and associated, and State 4 may refer to authenticated and associated, and having a verified authentication (such as verified shared key) for encrypted communication).

Additionally, the SMD may include, or be associated with, an authenticator that controls the multiple AP MLDs in the SMD. Thus, to enable the seamless roaming within the SMD, the non-AP MLD may perform an authentication procedure with the authenticator to establish a PMKSA 205, such as a PMKSA 205-a, associated with (such as storing) a pairwise master key (PMK) 210-a, and may derive (such as generate) a PTKSA 215, such as a PTKSA 215-a, from the PMKSA 205-a, as depicted in the key architecture 200-a. Additionally, each AP MLD in the SMD may use a same PTKSA 215 and a same PTKSA 215. As such, the non-AP MLD and each of the AP MLDs in the SMD may generate a same PTK 220, such as the PTK 220-a (stored in the PTKSA 215-a), which is used (by the non-AP MLD and each AP MLD) to generate a same TK 225, such as the TK 225-a. In such implementations, the non-AP MLD and the AP MLDs may use the TK 225-a to encrypt communications (such as frames) between the non-AP MLD and each AP MLD. That is, for example, the SMD may include a first AP MLD (such as a serving AP MLD) and a second AP MLD (such as a target AP MLD), and the non-AP MLD may roam from the first AP MLD to the second AP MLD. In such implementations, prior to roaming, the non-AP MLD may encrypt communications with the first AP MLD using the TK 225-a and, after roaming, may encrypt and decrypt communications with the second AP MLD also using the TK 225-a.

However, using the TK 225-a for encryption with all AP MLDs in the SMD may result in security vulnerabilities. For example, in some implementations, AP MLDs within the SMD may share the TK 225-a. The first AP MLD may transmit (such as physically share) an indication of the TK 225-a to the second AP MLD (such as a non-co-located AP MLD). In such implementations, if the indication is intercepted (such as received) by another device (such as an attacker, a malicious device), the other device may be capable of decrypting communications between the non-AP MLD and any of the AP MLDs in the SMD due to the AP MLDs in the SMD using the same TK 225 (such as the TK 225-a). If the other device intercepts (such as extracts) the indication of the TK 225-a and decrypts communications between the non-AP MLD and the first AP MLD (using the TK 225-a), the non-AP MLD roaming from the first AP MLD to the second AP MLD may not prevent the other device from continuing to decrypt communications transmitted and received by the non-AP MLD. In other words, the TK 225-a also may be compromised for the second AP MLD. Thus, in some deployments, using the same TK 225 for the multiple AP MLDs may not meet security thresholds (such as may not be acceptable).

Accordingly, techniques described herein may support per-AP MLD TKs 225 (in addition to a common TK 225). For example, an SMD may include multiple non-co-located AP MLDs, including at least a first AP MLD and a second AP MLD, controlled by an authenticator, and a non-AP MLD may be capable of seamlessly roaming between the multiple AP MLDS of the SMD. As such, to enable the seamless roaming within the SMD, the non-AP MLD may perform an authentication procedure with the authenticator to establish a PMKSA 205 (at an SMD level), such as a PMKSA 205-b, that stores a PMK 210-b. In such implementations, the PMKSA 205-b may be established using a MAC address associated with the SMD, which may be referred to as the SMD MAC address. That is, the PMK 210-b may use the SMD MAC address for an authentication address.

In some implementations, the non-AP MLD and each of the multiple AP MLDs may establish (such as derive) a single PTKSA 215, such as the PTKSA 215-b, from the PMKSA 205-b, as depicted in the key architecture 200-b. In some implementations (such as by default), a single, or common, TK 225, such as a TK 225-b, may be used by the multiple AP MLDs in the SMD, as described herein. That is, the non-AP MLD and the multiple AP MLDs may generate a PTK 220-b using the SMD MAC address (at the SMD level, using the SMD MAC address for an authentication address). For example, the PTK 220-b may be generated according to the following equation: PTK=PRF-Length(PMK, “Pairwise key expansion,” Min(AA, SPA) || Max (AA, SPA) || Min(ANonce, SNonce) || Max(ANonce, SNonce)), where the parameter “PTK” may represent the PTK 220-b, the parameter “PRF” may represent a pseudo-random, the parameter “Length” may represent a length of the PTK 220-b, the parameter “PMK” may represent the PMK 210-b, the parameter “Pairwise key expansion,” may represent a label, the parameter “AA” may represent an authentication address, the parameter “SPA” may represent a MAC address of a supplicant (such as the non-AP MLD), the parameter “ANonce” may represent a first nonce (such as first random value or a first pseudo-random number) selected by the authenticator, and the parameter “SNonce” may represent a second nonce (such as second random value or a second pseudo-random number) selected by the non-AP MLD. As described herein, the authentication address may be the SMD MAC address in the context of a single PTKSA 215. Additionally, the non-AP MLD and the multiple AP MLDs may generate a TK 225-b (in accordance with the PTK 220-b) and may use the TK 225-b to encrypt communications (such as frames) between the non-AP MLD and each AP MLD of the multiple AP MLDs. In other words, a same value of the TK 225-b may be stored at each AP MLD.

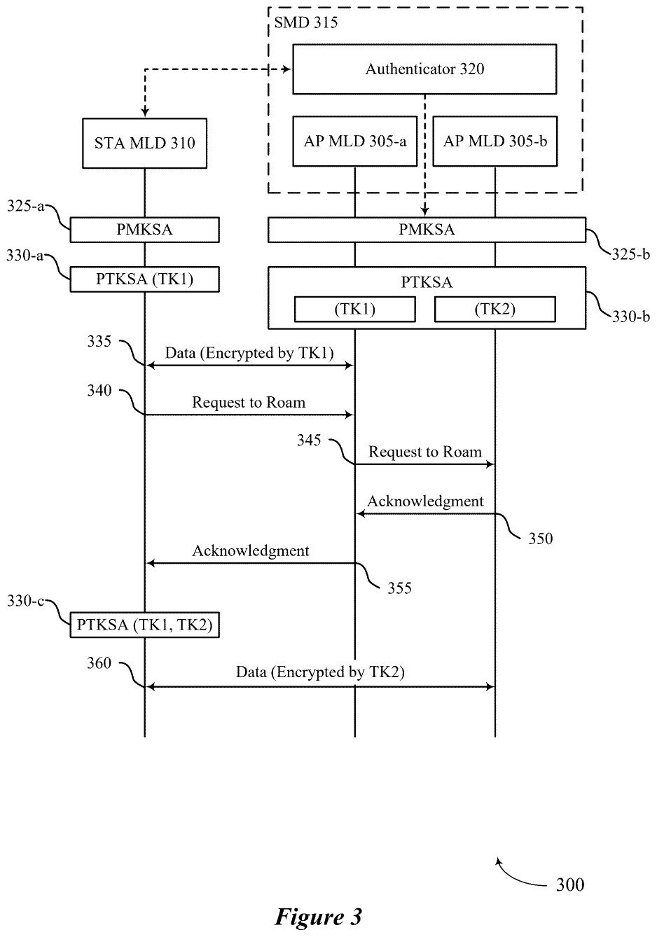

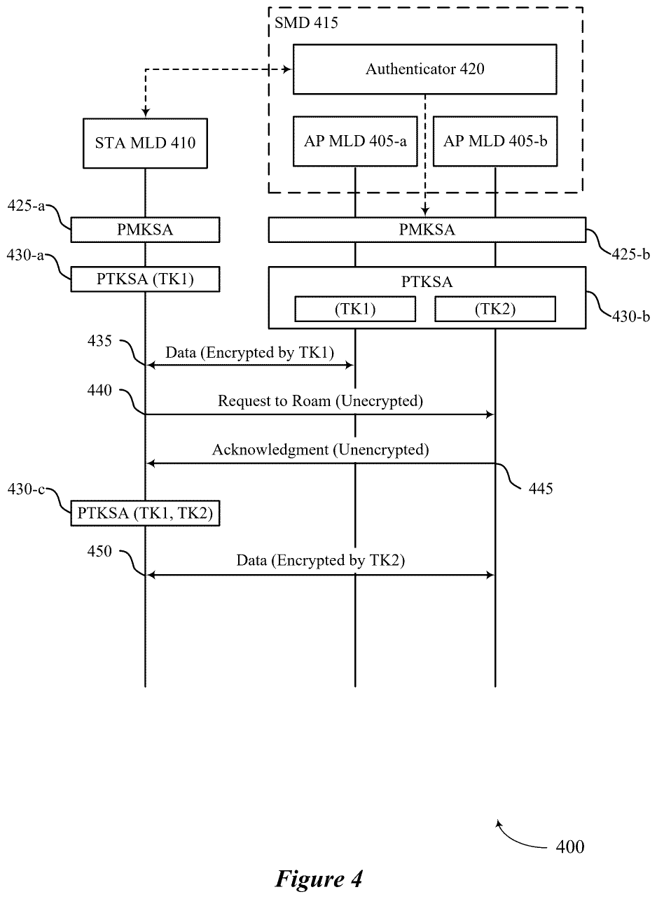

Additionally, or alternatively, multiple TKs 235, which may be referred to as per-AP MLD TKs 235, may be used by the multiple AP MLDs in the SMD. For example, the non-AP MLD and the multiple AP MLDs may generate a KDK 230 in accordance with the PMK 210-b and may additionally generate a per-AP MLD TK 235 (such as based on a per-AP MLD PTK) associated with each AP MLD (such as one PTK, and thus one TK 225, per AP MLD) in accordance with the KDK 230 and a respective MAC address. The non-AP MLD (and the first AP MLD) may generate a first PTK, and thus a TK 235-a, associated with the first AP MLD in accordance with the KDK 230 and a first MAC address associated with the first AP MLD, which may be referred to as a first MLD MAC address. Additionally, the non-AP MLD (and the second AP MLD) may generate a second PTK, and thus a TK 235-b, associated with the second AP MLD in accordance with the KDK 230 and a second MLD MAC address associated with the second AP MLD. Thus, as described further with reference to FIGS. 3 and 4, the non-AP STA may encrypt communications with the first AP MLD using the TK 235-a and may encrypt communications with the second AP MLD using the TK 235-b.

In some implementations, each per-AP MLD TK 235 may be generated according to the following equation: TK_{AP-MLD[i]}=KDF-Hash-Length(KDK, “SMD TK,” MLD-MAC-AddressAP-MLD[i]). In such implementations, the parameter “TK_{AP-MLD[i]}” may represent a per-AP MLD TK 235 for a given AP MLD, the parameter “KDF” may represent a key derivation function, the parameter “Hash” may represent a security hash, the parameter “Length” may represent a length of the per-AP MLD TK 235 (such as from a negotiated pairwise cipher suite, TK_{bits}), the parameter “KDK” may represent the KDK 230, the parameter “SMD TK” may represent a label, and the parameter “MLD-MAC-Address_{AP-MLD[i]}” may represent a MAC address of the given AP MLD. As described herein, each per-AP MLD TK 235 may be stored in the PTKSA 215-b on the non-AP MLD for each AP MLD that the non-AP MLD has roamed to. The non-AP MLD may not store a per-AP MLD TK 235 of an AP MLD that the non-AP MLD has not roamed to.

Additionally, in some implementations, each per-AP MLD TK 235 may be generated using a first nonce (such as ANonce) chosen by the authenticator, a second nonce (such as SNonce) chosen by the non-AP MLD, or both. For example, each per-AP MLD TK 235 may be generated according to the following equation: TK_{AP-MLD[i]}=KDF-Hash-Length(KDK, “SMD TK,” MLD-MAC-Address_{AP-MLD[i]}, ANonce, SNonce), where the parameter “ANonce” may represents the first nonce chosen by the authenticator and the parameter “SNonce” may represent the second nonce chosen by the non-AP MLD. In such implementations, the first nonce, the second nonce, or both, may be communicated between the non-AP MLD and the authenticator, prior to derivation of the per-AP MLD TKs 235. For example, the non-AP MLD may transmit an indication of the second nonce to the authenticator, the authenticator may transmit an indication of the first nonce to the non-AP MLD, or both. The communication of the indication of the first nonce, the second nonce, or both, may be over-the-air (OTA) or via a backhaul communication link.

In some implementations, the non-AP MLD may communicate an indication of whether to use a common TK 225 (such as the TK 225-b) or multiple per-AP MLD TKs 235 (such as the TK 235-a and the TK 235-b), where use of the common TK 225 or the multiple per-AP MLD TKs 235 is in accordance with the indication. For example, in some implementations, the non-AP MLD may receive (from the authenticator) the indication of whether to use the common TK 225 or the multiple per-AP MLD TKs 235. In such implementations, the use of the common TK 225 or the multiple per-AP MLD TKs 235 may be in accordance with one or more parameters associated with a network (including the authenticator, the multiple AP MLDs, the non-AP MLD, or any combination thereof), where the one or more parameters are in accordance with one or more network capabilities, a network configuration, or both. Additionally, or alternatively, the non-AP MLD may transmit (to the authenticator) an indication of a preference for using the common TK 225 or a preference for using the multiple per-AP MLD TKs 235.

In some other implementations, the non-AP MLD and each of the multiple AP MLDs may establish (such as derive) multiple PTKSAs 215 (such as per-AP MLD PTKSAs 215), such as a PTKSA 215-c and a PTKSA 215-d, from the PMKSA 205-b, as depicted in the key architecture 200-c. For example, the non-AP MLD may establish a PTKSA 215 associated with each AP MLD, such as a PTKSA 215-c associated with the first AP MLD and a PTKSA 215-d associated with the second AP MLD. In such implementations, each PTKSA 215 may be established (by the non-AP MLD and a respective AP MLD) using a respective MLD MAC address (at the AP MLD level, using a respective MLD MAC address for the authentication address). For example, as described herein, a PTK 220 may be generated according to PTK=PRF−Length(PMK, “Pairwise key expansion,” Min(AA, SPA) || Max (AA, SPA) || Min(ANonce, SNonce) || Max(ANonce, SNonce)). Thus, in the context of multiple PTKSAs 215, the authentication address (such as AA) may be an MLD MAC address of a respective AP MLD. For example, a PTK 220-c stored in the PTKSA 215-c and associated with the first AP MLD may be in accordance with the first MLD MAC address associated with the first AP MLD and a PTK 220-d stored in the PTKSA 215-d and associated with the second AP MLD may be in accordance with the second MLD MAC address associated with the second AP MLD.

Thus, each AP MLD may be associated with, or use, a different TK 225. For example, a TK 225-c may be generated (by the non-AP MLD and the first AP MLD) in accordance with the PTK 220-c, and a TK 225-d may be generated (by the non-AP MLD and the second AP MLD) in accordance with the PTK 220-d and, because the PTK 220-c is different than the PTK 220-d, the TK 225-c may be different than the TK 225-d. Thus, the non-AP MLD may encrypt communications with the first AP MLD using the TK 225-c and may encrypt communications with the second AP MLD using the TK 225-d.

In some implementations, the non-AP MLD may communicate an indication of whether to use the single PTKSA 215 (such as the PTKSA 215-b) or the multiple PTKSAs 215 (such as the PTKSA 215-c and the PTKSA 215-d), where using the single PTKSA 215 or the multiple PTKSAs 215 is in accordance with the indication. For example, in some implementations, the non-AP MLD may receive (from the authenticator) the indication of whether to use the single PTKSA 215 or the multiple PTKSAs 215. In such implementations, the use of the single PTKSA 215 or the multiple PTKSAs 215 may be in accordance with the one or more parameters associated with the network (including the authenticator, the multiple AP MLDs, the non-AP MLD, or any combination thereof), where the one or more parameters are in accordance with one or more network capabilities, a network configuration, or both. Additionally, or alternatively, the non-AP MLD may transmit (to the authenticator) an indication of a preference for using the single PTKSA 215 or a preference for using the multiple PTKSAs 215.

Supporting per-AP MLD TKs 235 may improve security in the SMD. Additionally, enabling the non-AP MLD to communicate the indication of whether to use the common TK 225 or the multiple per-AP MLD TKs 235 may enable some deployments (such as networks) to support a higher level of security and some other deployments to support a lower level of security (such as in accordance with system requirements).

FIG. 3 shows an example of a process flow 300 that supports authentication and security for UHR roaming. In some implementations, the process flow 300 may implement or be implemented by aspects of the example wireless communication network 100, the key architectures 200, or both. For example, the process flow 300 may implement or be implemented by one or more STAs 104 (such as of an STA MLD 310) and one or more APs 102 (such as of an AP MLD 305-a and an AP MLD 305-b), as described with reference to FIG. 1. In the following description of the process flow 300, the operations between the STA MLD 310, the AP MLD 305-a, and the AP MLD 305-b may be communicated in a different order than the example order shown, or the operations performed by the STA MLD 310, the AP MLD 305-a, and the AP MLD 305-b may be performed in different orders or at different times. Some operations also may be omitted from the process flow 300, and other operations may be added to the process flow 300.

In some implementations, as described herein, an SMD 315 may include multiple AP MLDs 305 (each including one or more APs 102), such as an AP MLD 305-a and an AP MLD 305-b, controlled by an authenticator 320, where an STA MLD 310 (including one or more STAs 104) may seamlessly roam between the multiple AP MLDs 305 in the SMD 315. In some implementations, as depicted in FIG. 3, the roaming may be via a serving AP MLD 305, such as the AP MLD 305-a.

At 325-a, the STA MLD 310 may establish, with the authenticator 320, a PMKSA at the STA MLD 310, where the PMKSA stores a PMK that is generated in accordance with an SMD MAC address associated with the SMD 315. Similarly, at 325-b, the authenticator may establish a PMKSA for the AP MLD 305-a and the AP MLD 305-b, where the PMKSA for the AP MLD 305-a and the AP MLD 305-b stores the same PMK that is generated in accordance with the SMD MAC address.

At 330-a, the STA MLD 310 may establish, with the authenticator 320, a PTKSA for the STA MLD 310, where the PTKSA is derived from the PMKSA and stores a KDK. At 330-a, the STA MLD 310 may additionally generate and store a first TK, or a TK1 (such as a PTK1), for use in communications with the AP MLD 305-a in accordance with the KDK and a first MLD MAC address associated with the AP MLD 305-a. At 330-b, the AP MLD 305-a (such as the authenticator) may similarly establish a PTKSA for the AP MLD 305-a and the AP MLD 305-b, where the PMKSA for the AP MLD 305-a stores the same KDK (as the PTKSA at the STA MLD 310). Thus, the AP MLD 305-a may generate and store the same TK1 for use in communications between the STA MLD 310 and the AP MLD 305-a in accordance with the KDK and the first MLD MAC address associated with the AP MLD 305-a. Additionally, the AP MLD 305-a may generate and store a TK2 (such as a PTK2) for use in communications between the STA MLD 310 and the AP MLD 305-b in accordance with the KDK and a second MLD MAC address associated with the AP MLD 305-b.

At 335, the STA MLD 310 may communicate with the AP MLD 305-a, where data (such as frames) communicated between the STA MLD 310 and the AP MLD 305-a are encrypted using the TK1.

In some implementations, the STA MLD 310 may seamlessly roam from the AP MLD 305-a to the AP MLD 305-b. In such implementations, seamlessly roaming from the AP MLD 305-a to the AP MLD 305-b may include, at 340, the STA MLD 310 transmitting, to the AP MLD 305-a, a request to roam to the AP MLD 305-b (such as a UHR Link Reconfiguration Request frame with a type indicating “ST Execution Request”), where the request is encrypted using the TK1. The AP MLD 305-b may decrypt the request using the TK1 and, at 345, may forward the unencrypted request to the AP MLD 305-b. Thus, at 350, the AP MLD 305-b may transmit, to the AP MLD 305-a, an unencrypted acknowledgment, or acceptance, of the request (such as a UHR Link Reconfiguration Response frame with a type indicating “ST Execution Response”). The AP MLD 305-a may encrypt the acknowledgment and, at 355, may forward the encrypted acknowledgment to the STA MLD 310.

At 330-c, the STA MLD 310 may generate the TK2 for use in communications with the AP MLD 305-b in accordance with the KDK and the second MLD MAC address associated with the AP MLD 305-b.

Additionally, at 360 (after completing the seamless roaming), the STA MLD 310 may communicate with the AP MLD 305-b, where data (such as frames) communicated between the STA MLD 310 and the AP MLD 305-b are encrypted using the TK2.

Though depicted in the context of the SMD 315 including the AP MLD 305-a and the AP MLD 305-b, this is not to be regarded as a limitation of the present disclosure. In this regard, the SMD 315 may include any quantity of AP MLDs 305.

FIG. 4 shows an example of a process flow 400 that supports authentication and security for UHR roaming. In some implementations, the process flow 400 may implement or be implemented by aspects of the example wireless communication network 100, the key architectures 200, the process flow 300, or any combination thereof. For example, process flow 400 may implement or be implemented by one or more STAs 104 (such as of an STA MLD 410) and one or more APs 102 (such as of an AP MLD 405-a and an AP MLD 405-b), as described with reference to FIG. 1. In the following description of the process flow 400, the operations between the STA MLD 410, the AP MLD 405-a, and the AP MLD 405-b may be communicated in a different order than the example order shown, or the operations performed by the STA MLD 410, the AP MLD 405-a, and the AP MLD 405-b may be performed in different orders or at different times. Some operations also may be omitted from the process flow 400, and other operations may be added to the process flow 400.

In some implementations, as described herein, an SMD 415 may include multiple AP MLDs 405 (each including one or more APs 102), such as an AP MLD 405-a and an AP MLD 405-b, controlled by an authenticator 420, where an STA MLD 410 (including one or more STAs 104) may seamlessly roam between the multiple AP MLDs 405 in the SMD 415. In some implementations, as depicted in FIG. 4, the roaming may be via a target AP MLD 405, such as the AP MLD 405-a.

At 425-a, the STA MLD 410 may establish, with the authenticator 420, a PMKSA at the STA MLD 410, where the PMKSA stores a PMK that is generated in accordance with an SMD MAC address associated with the SMD 415. Similarly, at 425-b, the authenticator may establish a PMKSA for the AP MLD 405-a and the AP MLD 405-b, where the PMKSA for the AP MLD 405-a and the AP MLD 405-b stores the same PMK that is generated in accordance with the SMD MAC address.

At 430-a, the STA MLD 410 may establish, with the authenticator 420, a PTKSA for the STA MLD 410, where the PTKSA is derived from the PMKSA and stores a KDK and a PTK. At 430-a, the STA MLD 410 may additionally generate and store a first TK, or a TK1, for use in communications with the AP MLD 405-a in accordance with the KDK and a first MLD MAC address associated with the AP MLD 405-a. At 430-b, the AP MLD 405-a (such as the authenticator) may similarly establish a PTKSA for the AP MLD 405-a and the AP MLD 405-b, where the PMKSA for the AP MLD 405-a stores the same KDK and the same PTK (such as the PTKSA at the STA MLD 410). Thus, the AP MLD 405-a may generate and store the same TK1 for use in communications between the STA MLD 410 and the AP MLD 405-a in accordance with the KDK and the first MLD MAC address associated with the AP MLD 405-a. Additionally, the AP MLD 405-a may generate and store a TK2 for use in communications between the STA MLD 410 and the AP MLD 405-b in accordance with the KDK and a second MLD MAC address associated with the AP MLD 405-b.

Thus, at 435, the STA MLD 410 may communicate with the AP MLD 405-a, where data (such as frames) communicated between the STA MLD 410 and the AP MLD 405-a are encrypted using the TK1.

In some implementations, the STA MLD 410 may seamlessly roam from the AP MLD 405-a to the AP MLD 405-b. In such implementations, seamlessly roaming from the AP MLD 405-a to the AP MLD 405-b may include, at 440, the STA MLD 410 transmitting, to the AP MLD 405-b, a request to roam to the AP MLD 405-b (such as a UHR Link Reconfiguration Request frame with a type indicating “ST Execution Request”), where the request is unencrypted. Additionally at 445, the AP MLD 405-b may transmit, to the STA MLD 410, an unencrypted acknowledgment, or acceptance, of the request (such as a UHR Link Reconfiguration Response frame with a type indicating “ST Execution Response”).

Thus, at 430-c, the STA MLD 410 may generate the TK2 for use in communications with the AP MLD 405-b in accordance with the KDK and the second MLD MAC address associated with the AP MLD 405-b.

Additionally, at 450 (after completing the seamless roaming), the STA MLD 410 may communicate with the AP MLD 405-b, where data (such as frames) communicated between the STA MLD 410 and the AP MLD 405-b are encrypted using the TK2.

Though depicted in the context of the SMD 415 including the AP MLD 405-a and the AP MLD 405-b, this is not to be regarded as a limitation of the present disclosure. In this regard, the SMD 415 may include any quantity of AP MLDs 405.

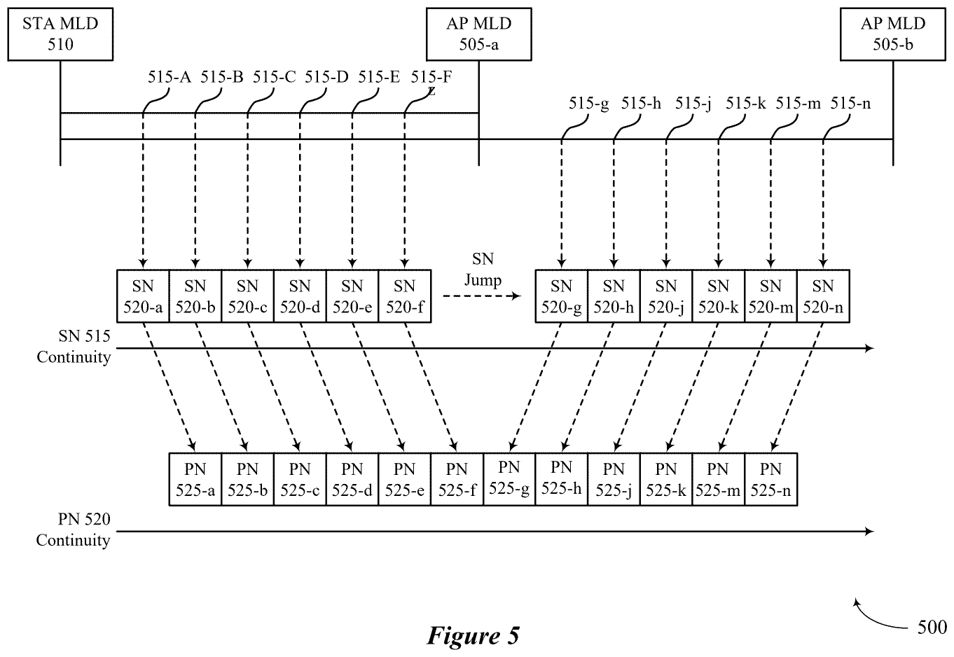

FIG. 5 shows an example of a timing diagram 500 that supports authentication and security for UHR roaming. In some implementations, the timing diagram 500 may implement or be implemented by aspects of the example wireless communication network 100, the key architectures 200, the process flow 300, the process flow 400, or any combination thereof. For example, the timing diagram 500 may implement or be implemented by one or more STAs 104 (such as of an STA MLD 510) and one or more APs 102 (such as of an AP MLD 505-a and an AP MLD 505-b), as described with reference to FIG. 1.

In some implementations, to facilitate reordering of packets 515 (such as downlink packets, packet data units (PDUs)) that are transmitted by different AP MLDs 505 (each include one or more APs 102), such as the AP MLD 505-a and the AP MLD 505-b during seamless roaming, a PN space may continue (such as monotonically increase) between the AP MLD 505-a, which may be a serving AP MLD 505, and the AP MLD 505-b, which may be a target AP MLD 505, regardless of whether the AP MLDs 505 use a common TK or per-AP MLD TKs (such as different TKs). In other words, PNs 525 for packets 515 may be maintained per PTKSA (at the SMD level). Thus, even though the AP MLD 505-a may use a different TK than the AP MLD 505-b (such as during a seamless roaming transitional period), the AP MLD 505-a and the AP MLD 505-b may share a same PTKSA, such that PNs 525 may continue (due to context transfer) and may increase monotonically from the AP MLD 505-a to the AP MLD 505-b (regardless of what TK value is used to encrypt a frame). In other words, the PN space may be shared between the AP MLD 505-a and the AP MLD 505-b (such as shared between a same TK or between different TKs).

For example, prior to roaming to the AP MLD 505-b, the STA MLD 510 may receive, from the AP MLD 505-a, a packet 515-a, a packet 515-b, a packet 515-c, a packet 515-d, a packet 515-e, and a packet 515-f and, after roaming to the AP MLD 505-b, may receive, from the AP MLD 505-b, a packet 515-g, a packet 515-h, a packet 515-j, a packet 515-k, a packet 515-m, and a packet 515-n. In such implementations, each packet 515 may be associated with a respective sequence number, SN 520 and a respective PN 525. For example, the packet 515-a may be associated, or include in a header, an SN 520-a and a PN 525-a, the packet 515-b may be associated with an SN 520-b and a PN 525-b, the packet 515-c may be associated with an SN 520-c and a PN 525-c, the packet 515-d may be associated with an SN 520-d and a PN 525-d, the packet 515-e may be associated with an SN 520-e and a PN 525-e, the packet 515-f may be associated with an SN 520-f and a PN 525-f, the packet 515-g may be associated with an SN 520-g and a PN 525-g, the packet 515-h may be associated with an SN 520-h and a PN 525-h, the packet 515-j may be associated with an SN 520-j and a PN 525-j, the packet 515-k may be associated with an SN 520-k and a PN 525-k, the packet 515-m may be associated with an SN 520-m and a PN 525-m, and the packet 515-n may be associated with an SN 520-n and a PN 525-n.

In such implementations, the SNs 520 (such as values of the SNs 520) may increase with each transmitted packet 515, such that SN continuity is retained between AP MLDs 505. For example, the SN 520-a may be less than the SN 520-b, which may be less than the SN 520-c, and so on. In some examples, a buffer (such as single reorder buffer) at each of the AP MLD 505-a and the AP MLD 505-b may buffer packets 515 in order of increasing SN 520.

In some implementations, after completing transmission of a last packet 515 (transmitted by the AP MLD 505-a), the AP MLD 505-b may transmit, to the AP MLD 505-b, a Block Ack Request (BAR), indicating a first SN 520 to be used by the AP MLD 505-b (such as with a switched service network (SSN) equal to the first SN 520). For example, the packet 515-f may be the last packet 515 transmitted by the AP MLD 505-a such that, after transmission of the packet 515-f, the AP MLD 505-a may transmit a BAR indicating the SN 520-g (as the first SN 520 to be used by the AP MLD 505-b). In some other implementations, the SN 520-g (such as the value of the SN 520-g) may be subsequent to and sequential to the SN 520-f (such as the value of the SN 520-f). For example, the SN 520-f may be equal to 6 and the SN 520-g may be equal to 7. In some other implementations, the SN 520-g may be subsequent to the SN 520-f but may not be sequential to the SN 520-f, such than an SN jump may occur between the packet 515-f and the packet 515-g. For example, the SN 520-f may be equal to 6 and the SN 520-g may be equal to 8.

Additionally, as described herein, the PN space may continue between the AP MLD 505-a and the AP MLD 505-b, such that the PNs 525 (such as values of the PNs 525) may increase with each transmitted packet 515 (and may not reset due to roaming), thus retaining PN continuity between AP MLDs 505. For example, the PN 525-a may be less than the PN 525-b, which may be less than the PN 525-c and so on, such that PN 525-f associated with the packet 515-f (such as the last packet 515 transmitted by the AP MLD 505-a) is less than the PN 525-g associated with the packet 515-g. The PN 525-g may be subsequent to (and in some implementations, sequential to) the PN 525-f. Continuing the PN space between AP MLDs 505 may reduce receiver complexity at the STA MLD 510 (as compared to resetting PNs 525 after roaming).

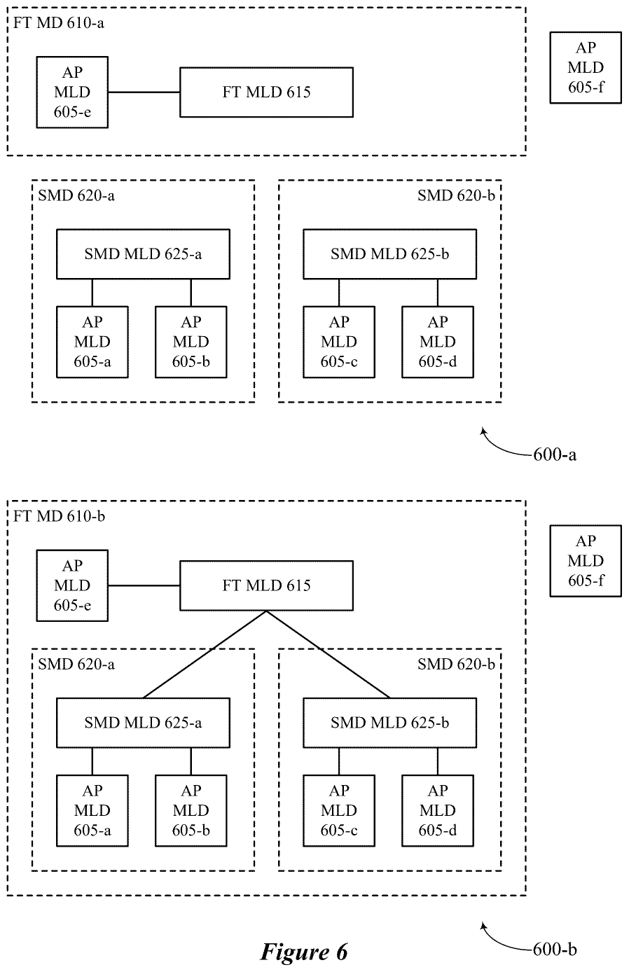

FIG. 6 shows example domain architectures 600 (such as a domain architecture 600-a and a domain architecture 600-b) that supports authentication and security for UHR roaming. In some implementations, the domain architectures 600 may implement or be implemented by aspects of the example wireless communication network 100, the key architectures 200, the process flow 300, the process flow 400, the timing diagram 500, or any combination thereof. For example, the domain architectures 600 may implement or be implemented by one or more STAs 104 and one or more APs 102 (such as of an AP MLD 605-a, an AP MLD 605-b, an AP MLD 605-c, and AP MLD 605-d, an AP MLD 605-e, and an AP MLD 605-f), as described with reference to FIG. 1.

In some implementations, as depicted in the domain architectures 600, an STA MLD may support a fast basic service set (BSS) transition (FT) mobility domain (MD) 610. The FT MD 610 may include an FT MLD 615 associated with one or more AP MLDs 605 (each including one or more APs 102), such as an AP MLD 605-e, where the STA MLD may be capable of transitioning between AP MLDs 605 in the FT MD 610 without re-authenticating at each AP MLD 605 in the FT MD 610.

In some implementations, as depicted in the domain architecture 600-a, an FT MD 610-a may not overlap with (such as may not include, may be separate from) one or more SMDs 620, such as an SMD 620-a and an SMD 620-b. In such implementations, each SMD 620 may establish respective PMKSAs and PTKSAs (and corresponding keys) in accordance with the techniques described herein.

Additionally, in such implementations, to support the FT MD 610-a, the STA MLD may generate a PMK-R0 and one or more PMK-R1's for FT roaming (such as regular FT roaming). In such implementations, the PMK-R0 for FT roaming (without seamless roaming) may be generated according to PMK-R0=ExtractBits(R0-Key-Data, 0, Q), where R0-Key-Data may be equal to KDF-Hash-Length(MPMK, “FT-R0,” SSIDlength || SSID || MDID || R0KHlength || S0KH-ID). In such implementations, the parameter “KDF” may represent a key derivation function, the parameter “Hash” may represent a security hash, the parameter “Length” may represent a length of the PMK-R0, the parameter “MPMK” may represent a Master PMK, the parameter “FT-R0” may represent a label, the parameter “SSID” may represent a service set identifier (SSID), the parameter “SSIDlength” may represent a length of the SSID, the parameter “MDID” may represent a mobility domain identifier (ID), the parameter “R0KHlength” may represent a length of an R0 Key Holder (R0KH), and the parameter “S0KH-ID” may represent a PMK S0 Key Holder ID (S0KH-ID). Additionally, in the implementations of FT roaming without seamless roaming, the MDID may be associated with the FT MD 610-a. The MDID may be an ID of the FT MD 610-a.

Additionally, the STA MLD may generate a respective PMK-R1 for FT (without seamless roaming) for each AP MLD 605 in the FT MD 610-a. For example, the, STA MLD may generate a first PMK-R1 associated with the AP MLD 605-e. In such implementations, each PMK-R1 for FT roaming (such as without seamless roaming) may be generated according to PMK-R1=KDF-Hash-Length(PMK-R0, “FT-R1,” R1KH-ID || S1KH-ID). In such implementations, the parameter “Length” may represent a length of the PMK-R1, the parameter “FT-R1” may represent a label, the parameter “R1KH-ID” may represent an identifier associated with an R1 Key Holder ID (R1KH-ID), and the parameter S1KH-ID may represent a PMK S0 Key Holder ID (SIKH-ID). For a given AP MLD 605 in the FT MD 610-a, the R1KH-ID may be in accordance with an MLD MAC address of the given AP MLD 605. Thus, PMK-R1's for FT roaming without seamless roaming may be an AP MLD level).

Thus, in the context of the domain architecture 600-a, the STA MLD may not support FT roaming between an AP MLD 605-a and an AP MLD 605-b in an SMD 620-a, as well as between an AP MLD 605-c and an AP MLD 605-d in an SMD 620-b, due to the AP MLD 605-a, the AP MLD 605-b, the AP MLD 605-c, and the AP MLD 605-d being outside of the FT MD 610-a. However, the STA MLD may seamlessly roam between the AP MLD 605-a and the AP MLD 605-b in the SMD 620-a and between the AP MLD 605-c and the AP MLD 605-a in the SMD 620-b. Additionally, or alternatively, the STA MLD may perform initial association with any AP MLD 605 in the domain architecture 600-a (including an AP MLD 605-f).

In some other implementations, as depicted in the domain architecture 600-b, an FT MD 610, such as an FT MD 610-b, may include one or more SMDs 620 (such as smaller MDs), where each SMD 620 is associated with a respective SMD MLD 625 (such as an SMD 625-a associated with the SMD 620-a and an SMD 625-b associated with the SMD 620-b). In such implementations, to support the FT MD 610-b (such as when a first SA is associated with the FT MD 610), the STA MLD may generate a PMK-R0 and one or more PMK-R1's for seamless roaming (such as FT roaming with seamless roaming). In such implementations, the PMK-R0 for seamless roaming may be generated according to PMK-R0=ExtractBits(R0-Key-Data, 0, Q), where R0-Key-Data may be equal to KDF-Hash-Length(MPMK, “SR-R0,” SSIDlength || SSID || MDID || R0KHlength || S0KH-ID), where the parameter “SR-R0” may represent a label. Additionally, the MDID may be associated with an SMD ID (such as a UHR SMD ID).

Additionally, the STA MLD may generate a respective PMK-R1 (and a respective PMK-R1 SA) for seamless roaming for each SMD 620 in the FT MD 610-b. For example, the STA MLD may generate a first PMK-R1 for the SMD 620-a and may generate a second PMK-R1 for the SMD 620-b. In such implementations, each PMK-R1 for seamless roaming may be generated according to PMK-R1=KDF-Hash-Length(PMK-R0, “SR-R1,” R1KH-ID || S1KH-ID), where the parameter “SR-R1” may represent a label. For a given SMD 620 in the FT MD 610-b, the R1KH-ID may be in accordance with an SMD MAC address of the given SMD 620. Thus, PMK-R1's for seamless roaming may be at an SMD level. Additionally, each SMD 620 in the FT MD 610-b may be associated with a respective PMK-R1 SA (at the SMD level).

Additionally, in some implementations, the STA MLD may generate a respective PTK (such as PTKSA) for each SMD 620. For example, the STA MLD may generate a first PTK for the SMD 620-a and a second PTK for the SMD 620-b. In such implementations, for a given SMD 620, the PTK may be generated according to PTK=KDF-Hash-Length(PMK-R1, “SR-PTK,” SNonce || ANonce || BSSID || STA-ADDR), where the parameter “Length” may represent a length of the PTK, the parameter PMK-R1 may represent a respective PMK-R1 associated with the SMD 620, the parameter “SR-PTK” may represent a label, the parameter “ANonce” may represent a first nonce selected by the authenticator, the parameter “SNonce” may represent a second nonce selected by the STA MLD, the parameter “BSSID” may represent a BSS identifier (BSSID), and the parameter “STA-ADDR” may represent a MAC address of an STA (such as a MLD MAC address of the STA MLD). For the given SMD 620 in the FT MD 610, the BSSID may be a SMD MAC address associated with the given SMD 620. Additionally, each SMD 620 in the FT MD 610-b may be associated with a respective PTKSA (at the SMD level). Generation of a common TK or per-AP MLD TKs (such as in accordance with the PTK) may be performed with reference to the techniques described herein.

In some other implementations, the STA MLD may generate a respective PTK for each AP MLD 605 in each SMD 620. For example, the STA MLD may generate a first PTK associated with the AP MLD 605-a, a second PTK associated with the AP MLD 605-b, a third PTK associated with the AP MLD 605-c, and a fourth PTK associated with the AP MLD 605-d. In such implementations, for a given AP MLD 605, the BSSID may be an MLD MAC address associated with the given AP MLD 605.

Thus, in the context of the domain architecture 600-b, the STA MLD may support FT roaming from any AP MLD 605 in the SMD 620-a to any AP MLD 605 in the SMD 620-b, as well as between AP MLDs 605 within an SMD 620 (such as between the AP MLD 605-a and the AP MLD 605-b). In some implementations, FT roaming between AP MLDs 605 within an SMD 620 may be disallowed (such as restricted) in accordance with a pre-configuration of the STA MLD, in accordance with signaling during initial association, or both. Additionally, the STA MLD may seamlessly roam between AP MLDs within an SMD 620 (such as between the AP MLD 605-a and the AP MLD 605-b) and may perform initial association with any AP MLD 605 in the domain architecture 600-b (including an AP MLD 605-f).

In some implementations, the STA MLD may communicate an indication of whether seamless roaming is supported in combination with FT roaming (such as in combination with FT roaming initial association, such as eFT, or enhanced FT) when initial association is performed with the FT MD 610. For example, in some implementations, the STA MLD may receive (such as from the authenticator) the indication of whether seamless roaming is supported in combination with FT. In such implementations, the use of the seamless roaming in combination with FT roaming may be in accordance with one or more parameters associated with a network (such as including an FT MD 610, one or more SMDs 620, or any combination thereof), where the one or more parameters are in accordance with one or more network capabilities, a network configuration, or both. Additionally, or alternatively, the STA MLD may transmit (such as to the authenticator) an indication of a preference for whether seamless roaming is supported in combination with FT roaming (such as whether the PMK-R0 and the one or more PMK-R1's support seamless roaming).

In some implementations, MDIDs (such as including those used for FT MDs 610 and those used for SMDs 620) may be unique within an extended service set (ESS).

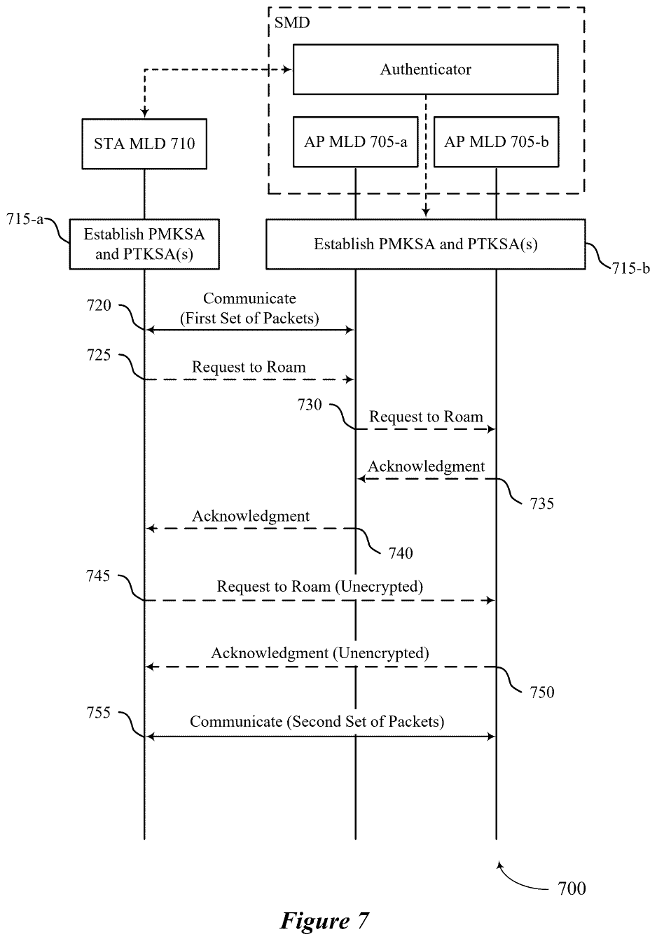

FIG. 7 shows an example of a process flow 700 that supports authentication and security for UHR roaming. In some implementations, the domain architectures 600 may implement or be implemented by aspects of the example wireless communication network 100, the key architectures 200, the process flow 300, the process flow 400, the timing diagram 500, the domain architectures 600, or any combination thereof. For example, the process flow 700 may implement or be implemented by one or more STAs 104 (such as of an STA MLD 710) and one or more APs 102 (such as of an AP MLD 705-a and an AP MLD 705-b), as described with reference to FIG. 1. In the following description of the process flow 700, the operations between the STA MLD 710, the AP MLD 705-a, and the AP MLD 705-b may be communicated in a different order than the example order shown, or the operations performed by the STA MLD 710, the AP MLD 705-a, and the AP MLD 705-b may be performed in different orders or at different times. Some operations also may be omitted from the process flow 700, and other operations may be added to the process flow 700.

At 715-a, the STA MLD 710 may establish, via an authenticator associated with an SMD, a PMKSA and one or more PTKSAs associated with an AP MLD 705-a, which may be a serving AP MLD 705, and an AP MLD 705-b, which may be a target AP MLD 705. In some implementations, a PMK associated with the PMKSA may be generated in accordance with an SMD MAC address associated with the SMD. At 715-b, the authenticator may similarly establish the PTKSA and the one or more PTKSAs associated with the AP MLD 705-a and the AP MLD 705-b.

In some implementations, the one or more PTKSAs may include a single PTKSA, where the single PTKSA is associated with KDK. In such implementations, the STA MLD 710 may generate a first TK associated with the AP MLD 705-a in accordance with the KDK and a first MLD MAC address of the AP MLD 705-a may generate a second TK associated with the AP MLD 705-b in accordance with the KDK and a second MLD MAC address of the AP MLD 705-b. In such implementations, the single PTKSA may be established in accordance with the SMD MAC address associated with the SMD. Additionally, in some implementations, the first TK and the second TK may be generated in accordance with a first pseudo-random number selected by the authenticator, a second pseudo-random number selected by the STA MLD 710, or both. In such implementations, the STA MLD 710 may receive, from the authenticator, an indication of the first pseudo-random number, may transmit, to the authenticator, an indication of the second pseudo-random number, or both.

In some other implementations, the one or more PTKSAs may include a first PTKSA associated with the AP MLD 705-a and a second PTKSA associated with the AP MLD 705-b. In such implementations, the STA MLD 710 may establish the first PTKSA in accordance with the first MLD MAC address of the AP MLD 705-a and may establish the second PTKSA in accordance with the second MLD MAC address of the AP MLD 705-b. Additionally, in such implementations, the first PTKSA may be associated with a first PTK used to generate the first TK, and the second PTKSA may be associated with a second PTK, different than the first PTK, used to generate the second TK.

In some implementations, the STA MLD 710 may determine whether to establish the single PTKSA or the multiple PTKSAs in accordance with a first indication. For example, the STA MLD 710 may receive an indication of whether the one or more PTKSAs includes the single PTKSA or the multiple PTKSA, where the one or more PTKSAs includes the single PTKSA or the multiple PTKSA in accordance with one or more parameters of the SMD. In such implementations, the one or more parameters may be in accordance with a network capability, a network configuration, or both. Additionally, or alternatively, the STA MLD 710 may transmit an indication of a preference for whether the one or more PTKSAs includes the single PTKSA or the multiple PTKSA.

Additionally, or alternatively, the STA MLD 710 may determine to use per-AP MLD TKs (such as per-AP device TKs or per-AP device PTKs) in accordance with a second indication. For example, the STA MLD 710 may receive an indication to use per-AP MLD TKs (such as per-AP MLD PTKs), where use of per-AP MLD TKs is in accordance with the one or more parameters of the SMD. Additionally, or alternatively, the STA MLD 710 may transmit an indication of a preference for use of per-AP MLD TKs.

In some implementations, the STA MLD 710 may support FT roaming with an FT domain, including at least the SMD, and may support seamless roaming within the SMD. For example, the PMKSA may be associated with both a PMK-R0 and a PMK-1 for seamless roaming, where the PMK-R1 is generated in accordance with the SMD MAC address. In some implementations, when the one or more PTKSAs includes the single PTKSA, a PTK associated with the single PTKSA may be generated in accordance with the PMK-R1. Additionally, or alternatively, an MDID associated with the PMK-R0 for seamless roaming based by an ID associated with the SMD (such as an SMDID). In some implementations, the STA MLD 710 may generate both the PMK-R0 and the PMK-1 for seamless roaming in accordance with a third indication, where the third indication is an indication of whether to support FT roaming or to support a combination of FT roaming and seamless roaming. For example, the STA MLD 710 may receive an indication that the PMK-R0 and the PMK-R1 support seamless roaming, may transmit an indication that the PMK-R0 and the PMK-R1 support seamless roaming, or both.

At 720, the STA MLD 710 may communicate with the AP MLD 705-a associated with the SMD in accordance with the first TK, where the first TK is generated in accordance with one of the one or more PTKSAs. For example, the STA MLD 710 may receive, from the AP MLD 705-a, a first set of packets, where a last received packet of the first set of packets is associated with a first PN. Additionally, or alternatively, the first TK may be used by the STA MLD 710 for encapsulation of a first setup link between the STA MLD 710 and the AP MLD 705-a.

Additionally, the STA MLD 710 may roam from the AP MLD 705-a to the AP MLD 705-b. The roaming may be via the AP MLD 705-a. At 725, the STA MLD 710 may transmit, to the AP MLD 705-a, a request to roam to the second AP device (such as a UHR Link Reconfiguration Request frame with a type indicating “ST Execution Request”), where the request is encrypted in accordance with the first TK. At 730, the AP MLD 705-b may forward the request to the AP MLD 705-b and, at 735, may receive, from the AP MLD 705-b, a response acknowledging the request to roam (which may not be a MAC layer 2(L2) acknowledgment). The response acknowledging the request to roam may be a UHR Link Reconfiguration Response frame with a type indicating “ST Execution Response.” At 740, the AP MLD 705-a may forward the response acknowledging the request to roam to the STA MLD 710, where the response is encrypted in accordance with the first TK.

In some other implementations, the roaming may be via the AP MLD 705-b. At 745, the STA MLD 710 may transmit, to the AP MLD 705-b, the request to roam to the second AP device, where the request is unencrypted, and, at 750, may receive, from the AP MLD 705-b, the response acknowledging the request to roam. In some other cases, the request to roam to the second AP device (at 7450, the response acknowledging the request (at 750), or both, may be encrypted with the second TK, where the second TK is generated in accordance with one of the one or more PTKSAs.

Thus, at 755, the STA MLD 710 may communicate with the AP MLD 705-b associated with the SMD in accordance with the second TK. For example, the STA MLD 710 may receive, from the AP MLD 705-b, a second set of packets, where a first received packet of the second set of packets is associated with a second PN that is subsequent to the first PN. In such implementations, the first received packet being associated with the second PN that is subsequent to the first PN may be in accordance with respective PNs of the second set of packets monotonically increasing from respective PNs of the first set of packets. In other words, the AP MLD 705-a and the AP MLD 705-b may be associated with a same PN space, where the same PN space is associated with the SMD. Additionally, or alternatively, the second TK may be used by the STA MLD 710 for encapsulation of a second setup link between the STA MLD 710 and the AP MLD 705-b.

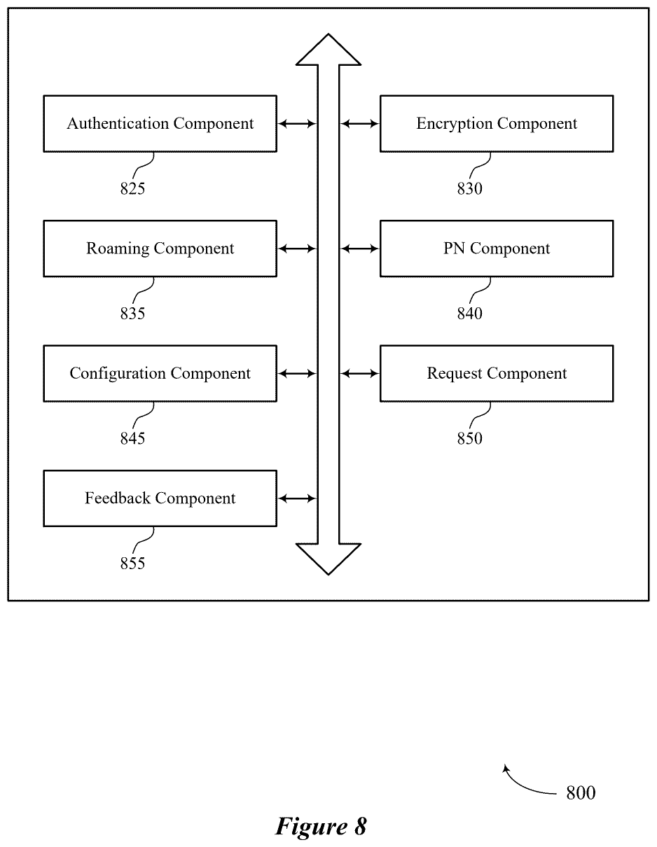

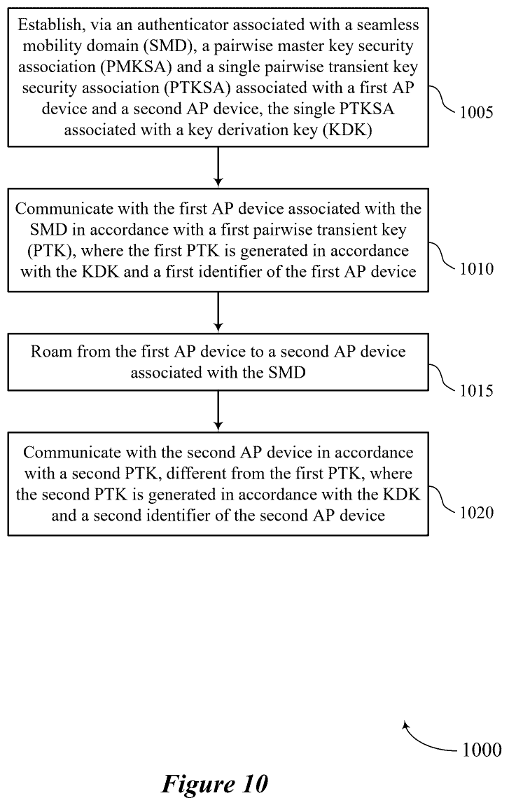

FIG. 8 shows a block diagram of an example wireless communication device 800 that supports authentication and security for UHR roaming. In some implementations, the wireless communication device 800 is configured to perform the process 1000 described with reference to FIG. 10. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is passed to the processing system. In some such implementations, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 800 can be configurable or configured for use in a STA, such as the STA 104 described with reference to FIG. 1. In some other implementations, the wireless communication device 800 can be a STA that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other implementations, the wireless communication device 800 can be configurable or configured to transmit and receive signals and communications conforming to one or more 3GPP specifications including those for 5G NR or 6G. In some implementations, the wireless communication device 800 also includes or can be coupled with one or more application processors which may be further coupled with one or more other memories. In some implementations, the wireless communication device 800 further includes a user interface (UI) (such as a touchscreen or keypad) and a display, which may be integrated with the UI to form a touchscreen display that is coupled with the processing system. In some implementations, the wireless communication device 800 may further include one or more sensors such as, for example, one or more inertial sensors, accelerometers, temperature sensors, pressure sensors, or altitude sensors, that are coupled with the processing system.

The wireless communication device 800 includes an authentication component 825, an encryption component 830, a roaming component 835, a PN component 840, a configuration component 845, a request component 850, and a feedback component 855. Portions of one or more of the authentication component 825, the encryption component 830, the roaming component 835, the PN component 840, the configuration component 845, the request component 850, and the feedback component 855 may be implemented at least in part in hardware or firmware. For example, one or more of the authentication component 825, the encryption component 830, the roaming component 835, the PN component 840, the configuration component 845, the request component 850, and the feedback component 855 may be implemented at least in part by at least a processor or a modem. In some implementations, portions of one or more of the authentication component 825, the encryption component 830, the roaming component 835, the PN component 840, the configuration component 845, the request component 850, and the feedback component 855 may be implemented at least in part by a processor and software in the form of processor-executable code stored in memory.

The wireless communication device 800 may support wireless communications in accordance with implementations as disclosed herein. The authentication component 825 is configurable or configured to establish, via an authenticator associated with a seamless mobility domain (SMD), a pairwise master key security association (PMKSA) and one or more pairwise transient key security associations (PTKSAs) associated with a first access point (AP) device and a second AP device. The encryption component 830 is configurable or configured to communicate with the first AP device associated with the SMD in accordance with a first temporal key (TK), where the first TK is generated in accordance with one of the one or more PTKSAs. The roaming component 835 is configurable or configured to roam from the first AP device to a second AP device associated with the SMD. In some implementations, the encryption component 830 is configurable or configured to communicate with the second AP device in accordance with a second TK, different from the first TK, where the second TK is generated in accordance with one of the one or more PTKSAs.

In some implementations, to support communicating with the first AP device, the PN component 840 is configurable or configured to receive, from the first AP device, a first set of packets, where a last received packet of the first set of packets is associated with a first packet number (PN). In some implementations, to communicate with the second AP device, the PN component 840 is configurable or configured to receive, from the second AP device, a second set of packets, where a first received packet of the second set of packets is associated with a second PN that is subsequent to the first PN.

In some implementations, the first received packet being associated with the second PN that is subsequent to the first PN is in accordance with respective PNs of the second set of packets monotonically increasing from respective PNs of the first set of packets.

In some implementations, the first received packet being associated with the second PN that is subsequent to the first PN is in accordance with the first AP device and the second AP device being associated with a same PN space. In some implementations, the same PN space is associated with the SMD.

In some implementations, the one or more PTKSAs includes a single PTKSA. In some implementations, the single PTKSA is associated with a key derivation key (KDK). In some implementations, the first TK is generated in accordance with the KDK and a first medium access control (MAC) address of the first AP device. In some implementations, the second TK is generated in accordance with the KDK and a second MAC address of the second AP device.

In some implementations, the single PTKSA is established in accordance with a third MAC address associated with the SMD.

In some implementations, the authentication component 825 is configurable or configured to receive, from the authenticator, an indication of a first pseudo-random number, where each of the first TK and the second TK are further generated in accordance with the first pseudo-random number, a second pseudo-random number generated by the STA device, or both.

In some implementations, the authentication component 825 is configurable or configured to transmit, to the authenticator, an indication of the second pseudo-random number.

In some implementations, the one or more PTKSAs includes a first PTKSA associated with the first AP device and a second PTKSA associated with the second AP device. In some implementations, the first PTKSA is established in accordance with a first medium access control (MAC) address of the first AP device. In some implementations, the second PTKSA is established in accordance with a second MAC address of the second AP device.

In some implementations, the first PTKSA is associated with a first PTK used to generate the first TK. In some implementations, the second PTKSA is associated with a second PTK, different than the first PTK, used to generate the second TK.

In some implementations, a pairwise master key (PMK) associated with the PMKSA is generated in accordance with a third medium access control address associated with the SMD.

In some implementations, the configuration component 845 is configurable or configured to receive an indication of whether the one or more PTKSAs includes a single PTKSA or a set of multiple PTKSA, where the one or more PTKSAs includes the single PTKSA or the set of multiple PTKSA in accordance with one or more parameters of the SMD, and where the one or more parameters are based on a network capability, a network configuration, or both.

In some implementations, the configuration component 845 is configurable or configured to transmit an indication of a preference for whether the one or more PTKSAs includes a single PTKSA or a set of multiple PTKSA.

In some implementations, the configuration component 845 is configurable or configured to receive an indication to use per-AP MLD TKs, where use of per-AP MLD TKs is in accordance with one or more parameters of the SMD, where the one or more parameters are based on a network capability, a network configuration, or both, and where the first TK being different than the second TK is in accordance with the indication.

In some implementations, the configuration component 845 is configurable or configured to transmit an indication of a preference for use of per-AP MLD TKs, where the first TK being different than the second TK is in accordance with the preference.

In some implementations, the STA device supports fast basic service set (BSS) transition (FT) roaming within an FT domain, including at least the SMD, and supports seamless roaming within the SMD. In some implementations, the PMKSA is associated with both a pairwise master key-R0 (PMK-R0) and a PMK-R1. In some implementations, the PMK-R1 is generated in accordance with a third medium access control (MAC) address associated with the SMD.

In some implementations, the one or more PTKSAs includes a single PTKSA. In some implementations, the single PTKSA is established in accordance with a third MAC address associated with the SMD. In some implementations, the single PTKSA is associated with a key derivation key (KDK). In some implementations, the first TK is generated in accordance with the KDK and a first MAC address of the first AP device. In some implementations, the second TK is generated in accordance with the KDK and a second MAC address of the second AP device.

In some implementations, a PTK associated with the single PTKSA is generated in accordance with the PMK-R1.

In some implementations, the one or more PTKSAs includes a first PTKSA associated with the first AP device and a second PTKSA associated with the second AP device. In some implementations, the first PTKSA is established in accordance with a first medium access control (MAC) address of the first AP device. In some implementations, the second PTKSA is established in accordance with a second MAC address of the second AP device.

In some implementations, a mobility domain identifier associated with the PMK-R0 for seamless roaming is an identifier associated with the SMD.

In some implementations, the configuration component 845 is configurable or configured to receive an indication that the PMK-R0 and the PMK-R1 support seamless roaming, where the PMK-R1 is generated in accordance with the third MAC address associated with the SMD in accordance with the indication.

In some implementations, the configuration component 845 is configurable or configured to transmit an indication of preference that the PMK-R0 and the PMK-R1 support seamless roaming, where the PMK-R1 is generated in accordance with the third MAC address associated with the SMD based on the preference.

In some implementations, to support roaming from the first AP device to the second AP device, the request component 850 is configurable or configured to transmit, to the first AP device, a request to roam to the second AP device, where the request is encrypted in accordance with the first TK. In some implementations, to support roaming from the first AP device to the second AP device, the feedback component 855 is configurable or configured to receive, from the first AP device, a response acknowledging the request to roam, where the response is encrypted in accordance with the first TK.

In some implementations, to support roaming from the first AP device to the second AP device, the request component 850 is configurable or configured to transmit, to the second AP device, a request to roam to the second AP device, where the request is unencrypted. In some implementations, to support roaming from the first AP device to the second AP device, the feedback component 855 is configurable or configured to receive, from the second AP device, a response acknowledging the request to roam, where the response is un-encrypted.

In some implementations, the first TK is used by the STA device for encapsulation of a first setup link between the STA device and the first AP device. In some implementations, the second TK is used by the STA device for encapsulation of a second setup link between the STA device and a second AP device.

In some implementations, the authenticator is associated with a set of AP MLDS in the SMD, including at least the first AP device and the second AP device. In some implementations, the STA device is capable of roaming between the set of AP MLDS.

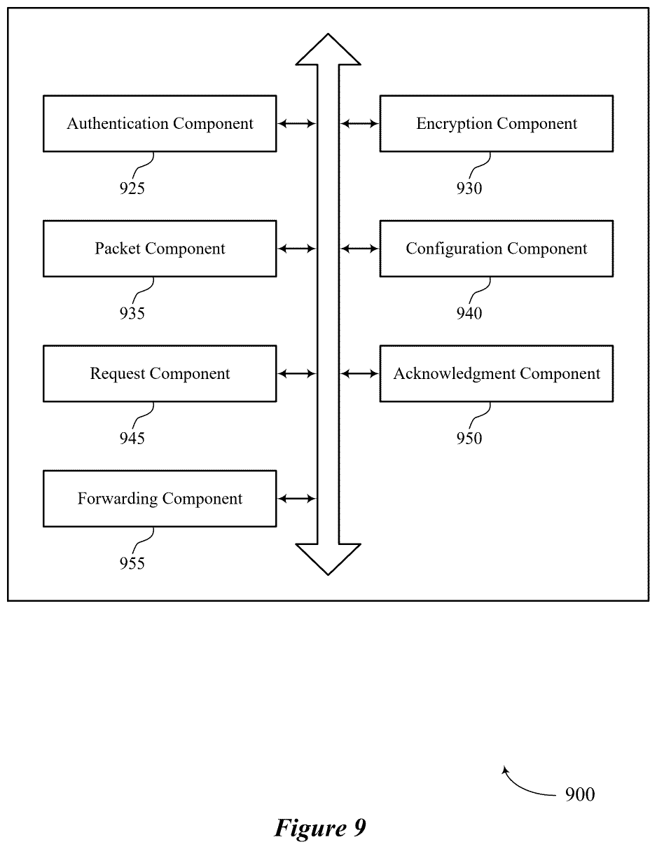

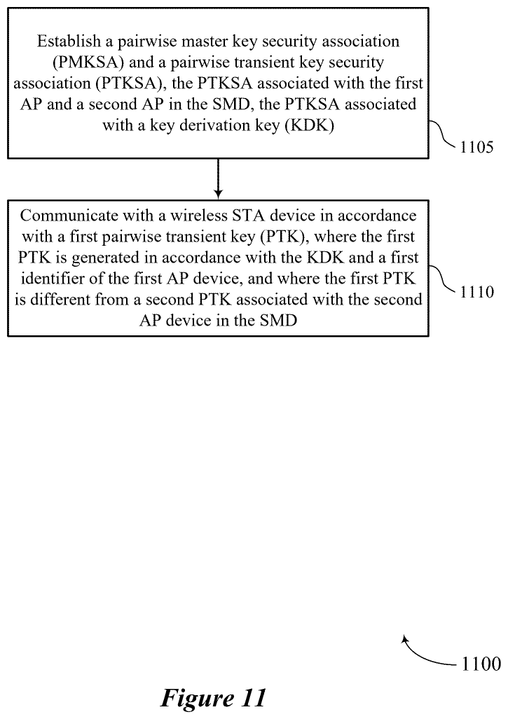

FIG. 9 shows a block diagram of an example wireless communication device 900 that supports authentication and security for UHR roaming. In some implementations, the wireless communication device 900 is configured to perform the process 1100 described with reference to FIG. 11. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is passed to the processing system. In some such implementations, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 900 can be configurable or configured for use in an AP, such as the AP 102 described with reference to FIG. 1. In some other implementations, the wireless communication device 900 can be an AP that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other implementations, the wireless communication device 900 can be configurable or configured to transmit and receive signals and communications conforming to one or more 3GPP specifications including those for 5G NR or 6G. In some implementations, the wireless communication device 900 also includes or can be coupled with one or more application processors which may be further coupled with one or more other memories. In some implementations, the wireless communication device 900 further includes at least one external network interface coupled with the processing system that enables communication with a core network or backhaul network that enables the wireless communication device 900 to gain access to external networks including the Internet.

The wireless communication device 900 includes an authentication component 925, an encryption component 930, a packet component 935, a configuration component 940, a request component 945, an acknowledgment component 950, and a forwarding component 955. Portions of one or more of the authentication component 925, the encryption component 930, the packet component 935, the configuration component 940, the request component 945, the acknowledgment component 950, and the forwarding component 955 may be implemented at least in part in hardware or firmware. For example, one or more of the authentication component 925, the encryption component 930, the packet component 935, the configuration component 940, the request component 945, the acknowledgment component 950, and the forwarding component 955 may be implemented at least in part by at least a processor or a modem. In some implementations, portions of one or more of the authentication component 925, the encryption component 930, the packet component 935, the configuration component 940, the request component 945, the acknowledgment component 950, and the forwarding component 955 may be implemented at least in part by a processor and software in the form of processor-executable code stored in memory.

The wireless communication device 900 may support wireless communications in accordance with implementations as disclosed herein. The authentication component 925 is configurable or configured to establish a pairwise master key security association (PMKSA) and a pairwise transient key security association (PTKSA) associated with the first AP device. The encryption component 930 is configurable or configured to communicate with a wireless station (STA) device in accordance with a first temporal key (TK), where the first TK is generated in accordance with the PTKSA, and where the first TK is different from a second TK associated with a second AP device in the SMD.

In some implementations, to support communicating with the STA device, the packet component 935 is configurable or configured to transmit, to the STA device, a first set of packets, where a first transmitted packet of the first set of packets is associated with a first packet number (PN) that is subsequent to a second PN associated with a last packet of a second set of packets transmitted by the second AP device, prior to first set of packets.

In some implementations, the first transmitted packet being associated with the first PN that is subsequent to the second PN is in accordance with respective PNs of the first set of packets monotonically increasing from respective PNs of the second set of packets.

In some implementations, the first transmitted packet being associated with the first PN that is subsequent to the second PN is in accordance with the first AP device and the second AP device being associated with a same PN space. In some implementations, the same PN space is associated with the SMD corresponding to the PTKSA.

In some implementations, the PTKSA associated with the first AP device is also associated with the second AP device. In some implementations, the PTKSA is associated with a key derivation key (KDK). In some implementations, the first TK is generated in accordance with the KDK and a first medium access control (MAC) address of the first AP device.

In some implementations, the PTKSA is established in accordance with a third MAC address associated with the SMD.

In some implementations, the first TK is further generated in accordance with a first pseudo-random number associated with an authenticator of the SMD, a second pseudo-random number associated with the STA device, or both.

In some implementations, the PTKSA is different than a second PTKSA associated with the second AP device. In some implementations, the PTKSA is established in accordance with a first medium access control (MAC) address of the first AP device.

In some implementations, the first PTKSA is associated with a first PTK used to generate the first TK. In some implementations, the second PTKSA is associated with a second PTK, different than the first PTK, used to generate the second TK.

In some implementations, a pairwise master key (PMK) associated with the PMKSA is generated in accordance with a third Medium access control (MAC) address associated with the SMD.

In some implementations, the configuration component 940 is configurable or configured to transmit an indication of whether the PTKSA is associated with the first AP device or both the first AP device and the second AP device, where the PTKSA is associated with the first AP device or both the first AP device and the second AP device in accordance with one or more parameters of the SMD, and where the one or more parameters are based on a network capability, a network configuration, or both.

In some implementations, the configuration component 940 is configurable or configured to receive an indication of a preference for whether the PTKSA is associated with the first AP device or both the first AP device and the second AP device.

In some implementations, the configuration component 940 is configurable or configured to transmit an indication to use per-AP MLD TKs, where use of per-AP MLD TKs is in accordance with one or more parameters of the SMD, and where the one or more parameters are based on a network capability, a network configuration, or both, and where the first TK being different than the second TK is in accordance with the indication.

In some implementations, the configuration component 940 is configurable or configured to receive an indication of a preference for use of per-AP MLD TKs, where the first TK being different than the second TK is in accordance with the preference.

In some implementations, the first AP device supports fast basic service set (BSS) transition (FT) roaming within an FT domain, including at least the SMD, and supports seamless roaming within the SMD. In some implementations, the PMKSA is associated with both a pairwise master key-R0 (PMK-R0) and a PMK-R1. In some implementations, the PMK-R1 is generated in accordance with a third medium access control (MAC) address associated with the SMD.

In some implementations, the PTKSA associated with the first AP device is also associated with the second AP device. In some implementations, the PTKSA is established in accordance with a third MAC address associated with the SMD. In some implementations, the PTKSA is associated with a key derivation key (KDK). In some implementations, the first TK is generated in accordance with the KDK and a first MAC address of the first AP device.

In some implementations, a PTK associated with the PTKSA is generated in accordance with the PMK-R1.

In some implementations, the PTKSA is different than a second PTKSA associated with the second AP device. In some implementations, the PTKSA is established in accordance with a first MAC address of the first AP device.

In some implementations, a mobility domain identifier associated with the PMK-R0 for seamless roaming is an identifier associated with the SMD.

In some implementations, the configuration component 940 is configurable or configured to transmit an indication that the PMK-R0 and the PMK-R1 support seamless roaming, where the PMK-R1 is generated in accordance with the third MAC address associated with the SMD in accordance with the indication.

In some implementations, the configuration component 940 is configurable or configured to receive a preference that the PMK-R0 and the PMK-R1 support seamless roaming, where the PMK-R1 is generated in accordance with the third MAC address associated with the SMD in accordance with the preference.

In some implementations, the request component 945 is configurable or configured to receive, from the STA device, a request to roam to the second AP device, where the request is encrypted in accordance with the first TK. In some implementations, the acknowledgment component 950 is configurable or configured to transmit, to the STA device, a response acknowledging the request to roam, where the response is encrypted in accordance with the first TK.

In some implementations, the forwarding component 955 is configurable or configured to forward, to the second AP device, the request to roam to the second AP device. In some implementations, the acknowledgment component 950 is configurable or configured to receive, from the second AP device, the response acknowledging the request to roam, where transmission of the response to the STA device is in response to reception of the response from the second AP device.

In some implementations, the request component 945 is configurable or configured to receive, from the STA device, a request to roam to the first AP device, where the request is unencrypted. In some implementations, the acknowledgment component 950 is configurable or configured to transmit, to the STA device, a response acknowledging the request to roam, where the response is un-encrypted, and where communicating with the STA device in accordance with a first TK is in accordance with transmission of the response.

In some implementations, the first TK is used by the first AP device for encapsulation of a first setup link between the STA device and the first AP device.

FIG. 10 shows a flowchart illustrating an example process 1000 performable by or at a wireless STA device that supports authentication and security for UHR roaming. The operations of the process 1000 may be implemented by a wireless STA device or its components as described herein. For example, the process 1000 may be performed by a wireless communication device, such as the wireless communication device 800 described with reference to FIG. 8, operating as or within a wireless STA. In some implementations, the process 1000 may be performed by a wireless STA, such as one of the STAs 104 described with reference to FIG. 1.

In some implementations, in 1005, the wireless STA device may establish, via an authenticator associated with a seamless mobility domain (SMD), a pairwise master key security association (PMKSA) and a single pairwise transient key security association (PTKSA) associated with a first AP device and a second AP device, the single PTKSA associated with a key derivation key (KDK). The operations of 1005 may be performed in accordance with implementations as disclosed herein. In some implementations, aspects of the operations of 1005 may be performed by an authentication component 825 as described with reference to FIG. 8.

In some implementations, in 1010, the wireless STA device may communicate with the first AP device associated with the SMD in accordance with a first pairwise transient key (PTK), where the first PTK is generated in accordance with the KDK and a first identifier of the first AP device. The operations of 1010 may be performed in accordance with implementations as disclosed herein. In some implementations, aspects of the operations of 1010 may be performed by an encryption component 830 as described with reference to FIG. 8.

In some implementations, in 1015, the wireless STA device may roam from the first AP device to a second AP device associated with the SMD. The operations of 1015 may be performed in accordance with implementations as disclosed herein. In some implementations, aspects of the operations of 1015 may be performed by a roaming component 835 as described with reference to FIG. 8.

In some implementations, in 1020, the wireless STA device may communicate with the second AP device in accordance with a second PTK, different from the first PTK, where the second PTK is generated in accordance with the KDK and a second identifier of the second AP device. The operations of 1020 may be performed in accordance with implementations as disclosed herein. In some implementations, aspects of the operations of 1020 may be performed by an encryption component 830 as described with reference to FIG. 8.

FIG. 11 shows a flowchart illustrating an example process 1100 performable by or at a first AP device associated with a seamless mobility domain (SMD) that supports authentication and security for UHR roaming. The operations of the process 1100 may be implemented by a first AP device associated with a seamless mobility domain (SMD) or its components as described herein. For example, the process 1100 may be performed by a wireless communication device, such as the wireless communication device 900 described with reference to FIG. 9, operating as or within a wireless AP. In some implementations, the process 1100 may be performed by a wireless AP, such as one of the APs 102 described with reference to FIG. 1.

In some implementations, in 1105, the first AP device associated with a seamless mobility domain (SMD) may establish a pairwise master key security association (PMKSA) and a pairwise transient key security association (PTKSA), the PTKSA associated with the first AP and a second AP in the SMD, the PTKSA associated with a key derivation key (KDK). The operations of 1105 may be performed in accordance with implementations as disclosed herein. In some implementations, aspects of the operations of 1105 may be performed by an authentication component 925 as described with reference to FIG. 9.

In some implementations, in 1110, the first AP device associated with a seamless mobility domain (SMD) may communicate with a wireless STA device in accordance with a first pairwise transient key (PTK), where the first PTK is generated in accordance with the KDK and a first identifier of the first AP device, and where the first PTK is different from a second PTK associated with the second AP device in the SMD. The operations of 1110 may be performed in accordance with implementations as disclosed herein. In some implementations, aspects of the operations of 1110 may be performed by an encryption component 930 as described with reference to FIG. 9.

Implementation implementations are described in the following numbered clauses:

The following provides an overview of aspects of the present disclosure:

Aspect 1: A method for wireless communications at a wireless STA device, including: establishing, via an authenticator associated with an SMD, a PMKSA and a single PTKSA associated with a first AP device and a second AP device, the single PTKSA associated with a KDK; communicating with the first AP device associated with the SMD in accordance with a first PTK, where the first PTK is generated in accordance with the KFK and a first identifier of the first AP device; roaming from the first AP device to a second AP device associated with the SMD; and communicating with the second AP device in accordance with a second PTK, different from the first PTK, where the second TK is generated in accordance with the KDK and a second identifier of the second AP device.

Aspect 2: The method of aspect 1, where the first PTK and the second PTK are different PTKs in accordance with the first PTK and the second PTK being per-AP MLD PTKs.

Aspect 3: The method of any of aspects 1 through 2, where the first PTK and the second PTK are generated in accordance with an identifier of the SMD.

Aspect 4: The method of any of aspects 1 through 3, where communicating with the first AP device includes: receiving, from the first AP device, a first set of packets, where a last received packet of the first set of packets is associated with a first PN, and where communicating with the second AP device includes: receiving, from the second AP device, a second set of packets, where a first received packet of the second set of packets is associated with a second PN that is subsequent to the first PN.

Aspect 5: The method of aspect 4, where the first received packet being associated with the second PN that is subsequent to the first PN is in accordance with respective PNs of the second set of packets monotonically increasing from respective PNs of the first set of packets.

Aspect 6: The method of any of aspects 4 through 5, where the first received packet being associated with the second PN that is subsequent to the first PN is in accordance with the first AP device and the second AP device being associated with a same PN space, and the same PN space is associated with the SMD.

Aspect 7: The method of any of aspects 1 through 6, where and the identifier of the first AP device includes a first MAC address of the first AP device, and the second identifier of the second AP device includes a second MAC address of the second AP device.

Aspect 8: The method aspect 7, further including: receiving, from the authenticator, an indication of a first pseudo-random number, where each of the first PTK and the second PTK are further generated in accordance with the first pseudo-random number, a second pseudo-random number generated by the STA device, or both.

Aspect 9: The method of aspect 8, further including: transmitting, to the authenticator, an indication of the second pseudo-random number.

Aspect 10: The method of any of aspects 1 through 9, where a PMK associated with the PMKSA is generated in accordance with an identifier of the SMD.

Aspect 11: The method of any of aspects 1 through 10, further including: receiving an indication of that the single PTKSA is to be used, where the single PTKSA is used in accordance with one or more parameters of the SMD, and where the one or more parameters are based on a network capability, a network configuration, or both.

Aspect 12: The method of any of aspects 1 through 11, further including: transmitting an indication of a preference for use of the single PTKSA.

Aspect 13: The method of any of aspects 1 through 12, further including: receiving an indication to use per-AP MLD PTKs, where use of per-AP MLD PTKs is in accordance with one or more parameters of the SMD, where the one or more parameters are based on a network capability, a network configuration, or both, and where the first PTK being different than the second PTK is in accordance with the indication.

Aspect 14: The method of any of aspects 1 through 13, further including: transmitting an indication of a preference for use of per-AP MLD PTKs, where the first PTK being different than the second PTK is in accordance with the preference.

Aspect 15: The method of any of aspects 1 through 14, where the STA device supports BSS FT roaming within an FT domain, including at least the SMD, and supports seamless roaming within the SMD, the PMKSA is associated with both a PMK-R0 and a PMK-R1, and the PMK-R1 is generated in accordance with an identifier of the SMD.

Aspect 16: The method of aspect 15, where the first PTK and the second PTK are generated in accordance with the PMK-R1.

Aspect 17: The method of any of aspects 15 through 16, where a mobility domain identifier associated with the PMK-R0 for seamless roaming is an identifier of the SMD.

Aspect 18: The method of any of aspects 15 through 17, further including: receiving an indication that the PMK-R0 and the PMK-R1 support seamless roaming, where the PMK-R1 is generated in accordance with the identifier of the SMD in accordance with the indication.

Aspect 19: The method of any of aspects 15 through 18, further including: transmitting an indication of preference that the PMK-R0 and the PMK-R1 support seamless roaming, where the PMK-R1 is generated in accordance with the identifier of the SMD based on the preference.

Aspect 20: The method of any of aspects 1 through 19, where roaming from the first AP device to the second AP device includes: transmitting, to the first AP device, a request to roam to the second AP device, where the request is encrypted in accordance with the first PTK; and receiving, from the first AP device, a response acknowledging the request to roam, where the response is encrypted in accordance with the first PTK.

Aspect 21: The method of any of aspects 1 through 20, where roaming from the first AP device to the second AP device includes: transmitting, to the second AP device, a request to roam to the second AP device, where the request is unencrypted; and receiving, from the second AP device, a response acknowledging the request to roam, where the response is un-encrypted.

Aspect 22: The method of any of aspects 1 through 21, where the first PTK is used by the STA device for encapsulation of a first setup link between the STA device and the first AP device, and the second PTK is used by the STA device for encapsulation of a second setup link between the STA device and a second AP device.

Aspect 23: The method of any of aspects 1 through 22, where the authenticator is associated with a set of AP MLDS in the SMD, including at least the first AP device and the second AP device, and the STA device is capable of roaming between the set of AP MLDS.

Aspect 24: A method for wireless communications at a first AP device associated with an SMD, including: establishing a PMKSA and a PTKSA, the PTKSA associated with the first AP and a second AP in the SMD, the PTKSA associated with a KDK; and communicating with an STA device in accordance with a first PTK, where the first PTK is generated in accordance with the KDK and a first identifier of the first AP device, and where the first PTK is different from a second PTK associated with a second AP device in the SMD.

Aspect 25: The method of aspect 24, where the first PTK and the second PTK are different PTKs in accordance with the first PTK and the second PTK being per-AP MLD PTKs.

Aspect 26: The method of any of aspects 24 through 25, where the first PTK and the second PTK are generated in accordance with an identifier of the SMD.

Aspect 27: The method of any of aspects 24 through 26, where communicating with the STA device includes: transmitting, to the STA device, a first set of packets, where a first transmitted packet of the first set of packets is associated with a first PN that is subsequent to a second PN associated with a last packet of a second set of packets transmitted by the second AP device, prior to first set of packets.

Aspect 28: The method of aspect 27, where the first transmitted packet being associated with the first PN that is subsequent to the second PN is in accordance with respective PNs of the first set of packets monotonically increasing from respective PNs of the second set of packets.

Aspect 29: The method of any of aspects 27 through 28, where the first transmitted packet being associated with the first PN that is subsequent to the second PN is in accordance with the first AP device and the second AP device being associated with a same PN space, and the same PN space is associated with the SMD corresponding to the PTKSA.

Aspect 30: The method of any of aspects 24 through 29, where the first identifier of the first AP device includes a first MAC address of the first AP device.

Aspect 31: The method aspect 30, where the first PTK is further generated in accordance with a first pseudo-random number associated with an authenticator of the SMD, a second pseudo-random number associated with the STA device, or both.

Aspect 32: The method of any of aspects 24 through 31, where a PMK associated with the PMKSA is generated in accordance with an identifier of the SMD.

Aspect 33: The method of any of aspects 24 through 32, further including: transmitting an indication that the PTKSA is to be used, where the PTKSA is used in accordance with one or more parameters of the SMD, and where the one or more parameters are based on a network capability, a network configuration, or both.

Aspect 34: The method of any of aspects 24 through 33, further including: receiving an indication of a preference for use of the PTKSA.

Aspect 35: The method of any of aspects 24 through 34, further including: transmitting an indication to use per-AP MLD PTKs, where use of per-AP MLD PTKs is in accordance with one or more parameters of the SMD, and where the one or more parameters are based on a network capability, a network configuration, or both, and where the first PTK being different than the second PTK is in accordance with the indication.

Aspect 36: The method of any of aspects 24 through 35, further including: receiving an indication of a preference for use of per-AP MLD PTKs, where the first PTK being different than the second PTK is in accordance with the preference.

Aspect 37: The method of any of aspects 24 through 36, where the first AP device supports BSS FT roaming within an FT domain, including at least the SMD, and supports seamless roaming within the SMD, the PMKSA is associated with both a PMK-R0 and a PMK-R1, and the PMK-R1 is generated in accordance with an identifier of the SMD.

Aspect 38: The method of aspect 37, where the first PTK is generated in accordance with the PMK-R1.
Aspect 39: The method of any of aspects 37 through 38, where a mobility domain identifier associated with the PMK-R0 for seamless roaming is an identifier of the SMD.

Aspect 40: The method of any of aspects 37 through 39, further including: transmitting an indication that the PMK-R0 and the PMK-R1 support seamless roaming, where the PMK-R1 is generated in accordance with the identifier of the SMD in accordance with the indication.

Aspect 41: The method of any of aspects 37 through 40, further including: receiving a preference that the PMK-R0 and the PMK-R1 support seamless roaming, where the PMK-R1 is generated in accordance with the identifier of the SMD in accordance with the preference.

Aspect 42: The method of any of aspects 24 through 41, further including: receiving, from the STA device, a request to roam to the second AP device, where the request is encrypted in accordance with the first PTK; and transmitting, to the STA device, a response acknowledging the request to roam, where the response is encrypted in accordance with the first PTK.

Aspect 43: The method of aspect 42, further including: forwarding, to the second AP device, the request to roam to the second AP device; and receiving, from the second AP device, the response acknowledging the request to roam, where transmission of the response to the STA device is in response to reception of the response from the second AP device.

Aspect 44: The method of any of aspects 24 through 43, further including: receiving, from the STA device, a request to roam to the first AP device, where the request is unencrypted; and transmitting, to the STA device, a response acknowledging the request to roam, where the response is un-encrypted, and where communicating with the STA device in accordance with a first PTK is in accordance with transmission of the response.

Aspect 45: The method of any of aspects 24 through 44, where the first PTK is used by the first AP device for encapsulation of a first setup link between the STA device and the first AP device.

Aspect 46: A wireless STA device for wireless communications, including one or more memories storing processor-executable code, and one or more processors coupled with the one or more memories and individually or collectively operable to execute the code to cause the wireless STA device to perform a method of any of aspects 1 through 23.

Aspect 47: A wireless STA device for wireless communications, including at least one means for performing a method of any of aspects 1 through 23.

Aspect 48: A non-transitory computer-readable medium storing code for wireless communications, the code including instructions executable by one or more processors to perform a method of any of aspects 1 through 23.

Aspect 49: A first AP device associated with an SMD for wireless communications, including one or more memories storing processor-executable code, and one or more processors coupled with the one or more memories and individually or collectively operable to execute the code to cause the first AP device associated with an SMD to perform a method of any of aspects 24 through 45.

Aspect 50: A first AP device associated with an SMD for wireless communications, including at least one means for performing a method of any of aspects 24 through 45.

Aspect 51: A non-transitory computer-readable medium storing code for wireless communications, the code including instructions executable by one or more processors to perform a method of any of aspects 24 through 45.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A wireless station (STA) device, comprising:
a processing system that includes processor circuitry and memory circuitry that stores code, the processing system configured to cause the STA device to:
establish, via an authenticator associated with a seamless mobility domain (SMD), a pairwise master key security association (PMKSA) and a single pairwise transient key security association (PTKSA) associated with a first access point (AP) device and a second AP device, the single PTKSA associated with a key derivation key (KDK);
communicate with the first AP device associated with the SMD in accordance with a first pairwise transient key (PTK), wherein the first PTK is generated in accordance with the KDK and a first identifier of the first AP device;
roam from the first AP device to a second AP device associated with the SMD; and
communicate with the second AP device in accordance with a second PTK, different from the first PTK, wherein the second PTK is generated in accordance with the KDK and a second identifier of the second AP device.

2. The STA device of claim 1, wherein the first PTK and the second PTK are different PTKs in accordance with the first PTK and the second PTK being per-AP MLD PTKs.

3. The STA device of claim 1, wherein the first PTK and the second PTK are generated in accordance with an identifier of the SMD.

4. The STA device of claim 1, wherein, to communicate with the first AP device, the processing system is configured to cause the STA device to:
receive, from the first AP device, a first set of packets, wherein a last received packet of the first set of packets is associated with a first packet number (PN), and wherein, to communicate with the second AP device, the processing system is further configured to cause the STA device to:
receive, from the second AP device, a second set of packets, wherein a first received packet of the second set of packets is associated with a second PN that is subsequent to the first PN.

5. The STA device of claim 4, wherein the first received packet being associated with the second PN that is subsequent to the first PN is in accordance with respective PNs of the second set of packets monotonically increasing from respective PNs of the first set of packets.

6. The STA device of claim 4, wherein the first received packet being associated with the second PN that is subsequent to the first PN is in accordance with the first AP device and the second AP device being associated with a same PN space, and wherein the same PN space is associated with the SMD.

7. The STA device of claim 1, wherein the first identifier of the first AP device comprises a first medium access control (MAC) address of the first AP device, and wherein the second identifier of the second AP device comprises a second MAC address of the second AP device.

8. The STA device of claim 7, wherein the processing system is further configured to cause the STA device to:
receive, from the authenticator, an indication of a first pseudo-random number, wherein each of the first PTK and the second PTK are further generated in accordance with the first pseudo-random number, a second pseudo-random number generated by the STA device, or both.

9. The STA device of claim 8, wherein the processing system is further configured to cause the STA device to:
transmit, to the authenticator, an indication of the second pseudo-random number.

10. The STA device of claim 1, wherein a pairwise master key (PMK) associated with the PMKSA is generated in accordance with an identifier of the SMD.

11. The STA device of claim 1, wherein the processing system is further configured to cause the STA device to:
receive an indication that the single PTKSA is to be used, wherein the single PTKSA is used in accordance with one or more parameters of the SMD, and wherein the one or more parameters are based on a network capability, a network configuration, or both.

12. The STA device of claim 1, wherein the processing system is further configured to cause the STA device to:
receive an indication to use per-AP multi-link device (MLD) PTKs, wherein use of per-AP MLD PTKs is in accordance with one or more parameters of the SMD, wherein the one or more parameters are based on a network capability, a network configuration, or both, and wherein the first PTK being different than the second PTK is in accordance with the indication.

13. The STA device of claim 1, wherein the STA device supports fast basic service set (BSS) transition (FT) roaming within an FT domain, including at least the SMD, and supports seamless roaming within the SMD, wherein the PMKSA is associated with both a pairwise master key-R0 (PMK-R0) and a PMK-R1, and wherein the PMK-R1 is generated in accordance with an identifier of the SMD.

14. The STA device of claim 13, wherein the first PTK and the second PTK are generated in accordance with the PMK-R1.

15. The STA device of claim 13, wherein a mobility domain identifier associated with the PMK-R0 for seamless roaming is an identifier of the SMD.

16. The STA device of claim 13, wherein the processing system is further configured to cause the STA device to:
transmit an indication of preference that the PMK-R0 and the PMK-R1 support seamless roaming, wherein the PMK-R1 is generated in accordance with the identifier of the SMD based on the preference.

17. The STA device of claim 1, wherein, to roam from the first AP device to the second AP device, the processing system is configured to cause the STA device to:
transmit, to the first AP device, a request to roam to the second AP device, wherein the request is encrypted in accordance with the first PTK; and
receive, from the first AP device, a response acknowledging the request to roam, wherein the response is encrypted in accordance with the first PTK.

18. The STA device of claim 1, wherein the first PTK is used by the STA device for encapsulation of a first setup link between the STA device and the first AP device, and wherein the second PTK is used by the STA device for encapsulation of a second setup link between the STA device and a second AP device.

19. A first access point (AP) device associated with a seamless mobility domain (SMD), comprising:
a processing system that includes processor circuitry and memory circuitry that stores code, the processing system configured to cause the first AP device associated with a seamless mobility domain (SMD) to:
establish a pairwise master key security association (PMKSA) and a pairwise transient key security association (PTKSA), the PTKSA associated with the first AP and a second AP in the SMD, the PTKSA associated with a key derivation key (KDK); and
communicate with a wireless station (STA) device in accordance with a first pairwise transient key (PTK), wherein the first PTK is generated in accordance with the KDK and a first identifier of the first AP device, and wherein the first PTK is different from a second PTK associated with the second AP device in the SMD.

20. A method for wireless communications at a wireless station (STA) device, comprising:
establishing, via an authenticator associated with a seamless mobility domain (SMD), a pairwise master key security association (PMKSA) and a single pairwise transient key security associations (PTKSA) associated with a first access point (AP) device and a second AP device, the single PTKSA associated with a key derivation key (KDK);
communicating with the first AP device associated with the SMD in accordance with a first pairwise transient key (PTK), wherein the first PTK is generated in accordance with the KDK and a first identifier of the first AP device;
roaming from the first AP device to a second AP device associated with the SMD; and
communicating with the second AP device in accordance with a second PTK, different from the first PTK, wherein the second PTK is generated in accordance with the KDK and a second identifier of the second AP device.
